(19) United States
(12) Patent Application Publication
(10) Pub. No.: US 2026/0308077 A1
(43) Pub. Date: Oct. 8, 2026

(54) Compositions and Methods for Agri-Inputs and Uses Thereof

(71) Applicant: Tidal Vision Products, Bellingham, WA (US)

(72) Inventors: Ramesh Raliya, Bellingham, WA (US); Yuan Cheng, Bellingham, WA (US); Prakash Mal, Vadodara, Gujarat (IN); Anthony DiMeglio, Bellingham, WA (US); Kevin Hammill, 3710 Irongate Road, WA (US); . Mahender, Vadodara, Gujarat (IN)

(21) Appl. No.: 19/482,714

(22) PCT Filed: May 8, 2024
(86) PCT No.: PCT/US2024/028440

§ 371 Date: Nov. 7, 2025

Related U.S. Application Data
(60) Provisional application No. 63/501,190, filed on May 10, 2023.

(30) Foreign Application Priority Data
May 8, 2023 (IN) 202311032522

(51) Int. Cl. C05C 11/00; A01C 21/00; C05C 3/00; C05C 9/00; C05G 5/10

(52) U.S. Cl. CPC C05C 11/00; A01C 21/007; C05C 3/00; C05C 9/00; C05G 5/10

(57) ABSTRACT

Disclosed herein are compositions comprising chitosan and at least 1% (w/v) nitrogen. In certain cases, at least 50% of the nitrogen is in chemical form of amine and/or nitrate and/or ammonia. Also disclosed herein are methods of producing chitosan nanoparticles by dissolving chitosan in acidic water, where the water is made acidic by an acid selected from the group of acetic acid, nitric acid, sulfuric acid, hydrochloric acid, and combinations thereof; and forming nanoparticles from the dissolved chitosan. Further disclosed is the treatment of plants or plant parts with the compositions disclosed herein.

### CROSS REFERENCE TO RELATED APPLICATIONS

This application is a national phase entry under 35 U.S.C. § 371 of International Patent Application PCT/US2024/028440, filed May 8, 2024, designating the United States of America and published in English as International Patent Publication WO 2024/233710 on Nov. 14, 2024, which claims the benefit under Article 8 of the Patent Cooperation Treaty to U.S. Patent Application Ser. No. 63/501,190, filed May 10, 2023, and Indian Patent Application number 202311032522, filed May 8, 2023, the entireties of which are hereby incorporated by reference.

### TECHNICAL FIELD

The invention relates to plant nutrition and specifically to association, encapsulation, functionalization, entrapment, and coating of agri-inputs such as nutrients.

### BACKGROUND

Agricultural production across the globe is facing unprecedented challenges due to climate change, extreme weather, soil erosion pathogen resistance and environmental pollution. Global population is projected to reach about 10 billion by 2050, thus the demand for food is expected to increase by 60%. The rate of increase of yield and fertilizer (an agri-input) to yield ratio achieved by the green revolution has been declining and detrimental climate change is expected to further limit crop productivity and nutritional quality. To increase yield and improve nutritional quality, plants require balanced nutrition in addition to water and sunlight. However, conventional agri-inputs and their delivery are highly inefficient due to low use efficiency and environmental release. Therefore, more-effective formulations and compositions which can stimulate plant growth, alleviate the negative effect of abiotic/biotic stress, deliver active ingredient efficiently to the plant at the right time in right quantity and release in response to plant's signal are required.

Biomass-based renewable materials are being explored globally due to their importance for a circular green economy and sustainability. Chitin is the most abundant natural amino polysaccharide. It is present most abundantly in crustaceans, insects, and fungi. Chitin and its derivatives are being considered as a new functional biomaterial of high potential in interdisciplinary applications. For instance, chitosan, a deacetylated derivative of chitin, is being used in industries/sectors such as medicine, textile, food, energy, and water. To date, translational application of chitosan in agriculture is under exploited.

### SUMMARY

In a first aspect, the disclosure provides methods of modifying chitosan for the formulation of chitosan-based nanoparticles.

In a second aspect, the disclosure provides chitosan-based nanoparticles and methods of making them. The chitosan-based nanoparticles may include nitrogen and/or a nitrogen rich compound and/or mixtures of compounds such as but not limited to potassium nitrate, calcium nitrate, magnesium nitrate, urea nitrate, urea ammonia nitrate, ammonium nitrate, ammonium hydroxide, ammonium sulfate, urea-hydroxyapatite, amino acids such as arginine, cystine, histidine, leucine, lysine, methionine, threonine, tryptophan, tyrosine, valine, glutamine, glutamic acid, glycine, proline, taurine, aspartic acid, serine, and alanine.

In a third aspect, the disclosure provides a method of treating a plant or a plant part. The method of treating the plant or plant part includes application with a composition comprising a chitosan-based nanoparticle. The chitosan-based nanoparticle may be in a solution, suspension, or formulation having a physical form that may be solid, liquid, or aerosol and may be applied to any plant part including a seed, leaf, stem, flower, fruit, or root of a plant throughout its life cycle. The method may include replacing an amount of a traditional nitrogen fertilizer or fertilizers with a solution of a chitosan-based nanoparticle.

In a fourth aspect, the chitosan-based nanoparticle may be used as part of a method of preparing a plant growth medium. For example, the method may include treating the growth medium with a chitosan-based nanoparticle solution. The growth medium may be soil, peat, moss, wood residue, leaf mold, sawdust, bark, bagasse, rice hull, sand, perlite, vermiculite, calcinated clay, polystyrene, urea formaldehyde resins, agar or agarose and hydroponic liquids, in vitro and in vivo plant tissue culture medium used for either hybrid, genetically modified or non-genetically modified seed/plant varieties and combinations thereof.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a depiction of Morphological characterizations of the liquid chitosan formulation (TgA-TgE) obtained by Electron Microscopy.

FIG. 2 is a depiction of Morphological characterizations of the liquid chitosan formulation (CTgA-CTgE) obtained by Electron Microscopy.

FIG. 3 is a depiction of Colloidal characterization with reference to hydrodynamic size of the liquid chitosan formulation (TgA-E and CTgA-CTgE) obtained by Dynamic Light Scattering.

FIG. 4 is a depiction of Colloidal characterization with reference to surface zeta potential of the liquid chitosan formulation (TgA-E and CTgA-CTgE) obtained by Dynamic Light Scattering.

FIG. 5 is a table depicting the pH and TKN of Chitosan-based nanoparticle Batches 1-7.

FIG. 6 is the UV wavelength analysis of Chitosan-based nanoparticle Batches 1-7.

FIG. 7 is the FTIR analysis of Chitosan-based nanoparticle 1.

FIG. 8 is the FTIR analysis of Chitosan-based nanoparticle 2.

FIG. 9 is the FTIR analysis of Chitosan-based nanoparticle 3.

FIG. 10 is the FTIR analysis of Chitosan-based nanoparticle 4.

FIG. 11 is the FTIR analysis of Chitosan-based nanoparticle 5.

FIG. 12 is the FTIR analysis of Chitosan-based nanoparticle 6.

FIG. 13 is the FTIR analysis of Chitosan-based nanoparticle 7.

FIG. 14 is a graph of the phytotoxicity of a formulation of Chitosan-based nanoparticle used in a hydroponic system.

FIG. 15 is a graph of the vigor rating after application of a formulation of Chitosan-based nanoparticle used in a hydroponic system.

FIG. 16 is a graph of the plant width changes after application of a formulation of Chitosan-based nanoparticle used in a hydroponic system.

FIG. 17 is a graph of the shoot weight after application of a formulation of Chitosan-based nanoparticle used in a hydroponic system.

FIG. 18 is a graph of the root weight after application of a formulation of Chitosan-based nanoparticle used in a hydroponic system.

FIG. 19A is a graph of the total harvest weight of corn after foliar application of multiple different formulations to different plots of corn.

FIG. 19B is a graph of the nitrogen percentage present in leaf tissue samples at the V8 stage of corn growth.

FIG. 20 is a graph of the effects of a formulation of the chitosan-based nanoparticle when added to corn planted with nitrogen fertilizers according to standard agricultural practices, and when added to corn planted with nitrogen fertilizers according to standard agricultural practices less 40 lbs (18.14 kg) of soil applied nitrogen.

FIG. 21 is a graph of the effects of a formulation of the chitosan-based nanoparticle with glyphosate.

FIG. 22 is a graph of the effects of a formulation of the chitosan-based nanoparticle with 2,4-D.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein “chitosan-based nanoparticle” means a particle comprising chitosan to which a nutrient containing molecule is coupled, attached, functionalized, or encapsulated via ionic, non-ionic, non-covalent, or covalent intermolecular or intramolecular bonds, or entrapped within a polymeric matrix of chitosan. The nutrient in the nutrient containing molecule may be nitrogen. The nutrient may be any primary macronutrient, secondary macronutrient, or micronutrient. Such nutrients include phosphorous (P), Potassium (K), calcium (Ca), magnesium (Mg), sulfur(S), iron (Fe), zinc (Zn), copper (Cu), manganese (Mn), molybdenum (Mo), Nickel (Ni), and boron (B) and combinations thereof.

Several formulations for chitosan-based nanoparticles and chitosan-based nanoparticle solutions have been produced under the trademark alignN®.

As used herein “associated with or association” means molecules which are attached, coupled, functionalized, entrapped, coated, encapsulated, or otherwise joined together. Such joining may be accomplished by ionic, non-ionic, non-covalent, or covalent bonding.

As used herein “traditional nitrogen fertilizer” means any substance added to soil or directly to plants which boost the availability of nitrogen for the plant. These fertilizers may be granular or liquid. Granular fertilizers are pellets that can be spread around plants or broadcast across fields. Liquid fertilizers can be absorbed by plants when applied through irrigation systems or sprayed directly on foliage. Such fertilizers have nitrogen in one of several forms including ammonia, ammonium, urea, and nitrate.

As used herein, “phytotoxicity” means any adverse effects on plant growth, physiology, or metabolism caused by a chemical substance, such as elevated levels of fertilizers, herbicides, heavy metals, or nanoparticles. General phytotoxic effects include altered plant metabolism, growth inhibition, or plant death. Changes to plant metabolism and growth are the result of disrupted physiological functioning, including inhibition of photosynthesis, water and nutrient uptake, cell division, or seed germination.

Association and slow release of nutrients is one method for balancing the nutritional needs of plants. One such nutritional need is nitrogen in the form of amine, nitrate, ammonium, and ammonia. Association of nitrogen compounds having chemical functional groups as amine, nitrate, ammonia, ammonium, or any one or all of these such as but not limited to potassium nitrate, calcium nitrate, magnesium nitrate, urea nitrate, urea ammonia nitrate, ammonium nitrate, ammonium hydroxide, ammonium sulfate, urea-hydroxyapatite, amino acids such as arginine, cystine, histidine, leucine, lysine, methionine, threonine, tryptophan, tyrosine, valine, glutamine, glutamic acid, glycine, proline, taurine, aspartic acid, serine and alanine, and all possible combinations thereof, is a way of releasing nitrogen in effective amounts for plant growth utilization. There are several benefits of the use of chitosan as a nitrogen-association agent. The first benefit is that the chitosan polymer is bio-safe and biodegradable. The chitosan polymer has a biological origin and has been used for immobilization of enzymes for food and in biosensing applications. Chitosan can be harvested from fungus, shrimp, crab, lobster, or any combination of these sources. A second benefit, compared to inorganic coatings such as sulfur coatings, is the absence of cracks. Cracks in the coating cause an immediate release of the coated nutrient upon contact with water. Immediate release of the nutrient defeats the purpose of the association, which is to slowly release the nutrient. A third benefit of the chitosan polymer is the overall health of the soil. The chitosan polymer results in lowered acidification of the soil. Acidification can of the soil can be detrimental to specific plant species. Coatings such as sulfur lower the pH of the soil. Additionally, the soil microbes are an important part of soil health. Synthetic polymers cannot be metabolized by soil microbes.

Embodiments include chitosan-based nanoparticles. In certain embodiments the chitosan-based nanoparticles comprise nitrogen in the form of amine and/or nitrate and/or ammonia, and/or ammonium. The nitrogen may be associated, coupled to, adhered to, or associated by/in the chitosan-based nanoparticles. In particular embodiments, the nitrogen is in the form of amine, nitrate, ammonium, and/or ammonia may be selected potassium nitrate, calcium nitrate, magnesium nitrate, urea nitrate, urea ammonia nitrate, ammonium nitrate, ammonium hydroxide, ammonium sulfate, urea-hydroxyapatite, amino acids such as arginine, cystine, histidine, leucine, lysine, methionine, threonine, tryptophan, tyrosine, valine, glutamine, glutamic acid, glycine, proline, taurine, aspartic acid, serine, alanine, and all combinations thereof.

In certain embodiments, the chitosan-based nanoparticles may comprise at least 1, 5, 10, 15, 20, 25, 30, 35, 40, 45, 50, 55, 60, 65, 70, 75, 85, 90, or 95% (w/v) nitrogen.

In particular embodiments wherein at least 50, 55, 60, 65, 70, 75, 85, 90, or 95% of the nitrogen is in the chemical form of the amine and/or nitrate, ammonium, and/or ammonia. In certain embodiments, the chitosan-based nanoparticles may comprise about 19.87% (w/v) nitrogen. In certain embodiments, the chitosan-based nanoparticles may comprise about 15.64% (w/v) nitrogen.

In certain embodiments, the chitosan-based nanoparticles may comprise at least 1, 5, 10, 15, 20, 25, 30, 35, 40, 45, 50, 55, 60, 65, 70, 75, 85, 90, or 95% (w/w) nitrogen. In particular embodiments wherein at least 50, 55, 60, 65, 70, 75, 85, 90, or 95% of the nitrogen is in the chemical form of the amine and/or nitrate and/or ammonia, and/or ammonium. In certain embodiments, the chitosan-based nanoparticles may comprise about 16.15% (w/w) nitrogen. In certain embodiments, the chitosan-based nanoparticles may comprise about 13.37% (w/w) nitrogen.

In certain embodiments, the chitosan-based nanoparticles may comprise at least 5, 10, 15, 20, 25, 30, 35, or 40% (w/v) total nitrogen, and at least 5, 10, 15, 20, 25, or 30% nitrogen from urea, and at least 1, 5, 10, 15, or 20% nitrogen from ammonium sulphate.

In certain embodiments, the chitosan-based nanoparticles may comprise Chitosan=0.3%, Total Nitrogen (w/v)=15.64%, Total Ammonium Sulphate (with linker)=19.06%, N in Urea=11.65%, N in AS=3.99%, S in AS=4.62%, Sulfate=13.84, Potassium sorbate: 0.01%,

In certain embodiments, the chitosan-based nanoparticles may comprise at least 5, 10, 15, 20, 25, 30, 35, or 40% (w/v) total nitrogen, and at least 5, 10, 15, 20, 25, or 30% nitrogen from urea, and at least 1, 5, 10, 15, or 20% nitrogen from ammonium sulphate.

In certain embodiments, the chitosan-based nanoparticles may comprise Chitosan=0.2%, Total Nitrogen (w/v)=19.87%, Total Ammonium Sulphate (with linker)=37.7%, N in Urea=11.96%, N in AS=7.91%, S in AS=9.1%, Sulfate=27.4, Potassium sorbate: 0.01%,

In one embodiment, the process for forming the chitosan-based nanoparticles begins with the chitosan polymer. The source of chitosan can be fungus, shrimp, crab, lobster, or squid pens, or a mixture of them. In certain embodiments the chitosan has a Degree of DeAcetylation (DDA): >80%, MW: <110 KDa. In particular embodiments the DDA is >85%. The DDA may be 90%. The DDA may be >95%. In particular embodiments the DDA is about 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%.

Prior to usage for the formulation of nanoparticles, the chitosan must be dissolved in a solution. Dissolution medium: acidic water having pH ranges between 1 and 6.5 or having a pH<1, <2, <3, <4, <5, <5.5. The acid used may be any acid. In particular embodiments the acid used is one of or a combination of the acid including any one or more of Acetic acid, Citric acid, Lactic acid, Malic acid, Tartaric acid, Formic acid, Acetylsalicylic acid, Oxalic acid, Succinic acid, Benzoic acid, Folic acid, Pyruvic acid, Butyric acid, Propionic acid, Caproic acid, Hydrochloric acid, Sulfuric acid, Nitric acid, Phosphoric acid, Hydrofluoric acid, aPerchloric acid, Hydrobromic acid, Hydroiodic acid, Chloric acid, Bromic acid, Iodic acid Humic acid, Fulvic acid, Amino acid, Nucleic acids (DNA and RNA), Boric acid, Chromic acid, Cyanuric acid, Hyaluronic acid, Arsenic acid and Carboxylic acid, and hydrogen peroxide and carbon dioxide. To dissolve the chitosan, the aqueous acidic solution may be kept at temperature between about 68 and about 212 degrees F. In particular embodiments, the temperature is kept at about 68, 72, 82, 92, 201, 112, 122, 132, 142, 152, 162, 172, 182, 192, 202, or 212 degrees F. During the entire reaction period the solution may be kept stirring at rpms between about 50 and about 2500 rpm. After completion of the reaction, typically between 0.3 and 4 hours, the solution was filtered through 200 mesh (74 micron) followed by more than 635 mesh (<20 micron). In the filtered solution, antimicrobial agents such as but not limited to potassium sorbate are added (0.1% v/v). In certain cases, as described below a coupling enhancer such as sodium tripolyphosphate and/or ammonium sulfate is added in the solution before the addition of antimicrobial agents.

In one embodiment, the reaction is carried out with specific solutions prepared in accordance with one and/or all of the procedures in Example 1 at the temperature between 68 and 250 degrees F. During the entire reaction period the solution was kept stirring at 400 rpm for uniformity of the substances. After completion of the reaction, typically between 0.3 and 4 hours, the solution was filtered through 200 mesh (74 micron) followed by more than 635 mesh (<20 micron). The nitrogen % in the final solution was maintained between 0.1% and 100%, specifically between 18-24% using the compound and/or mixture of compounds described above.

In certain embodiments, the chitosan-based nanoparticles may be formed in the presence of and or loaded with nitrogen in the form of amine and/or nitrate and/or ammonia and/or ammonium. The nitrogen may be at least partially associated by/in the chitosan-based nanoparticles. In particular embodiments, the nitrogen in the form of amine, nitrate, ammonium, and/or ammonia may be selected potassium nitrate, calcium nitrate, magnesium nitrate, urea nitrate, urea ammonia nitrate, ammonium nitrate, ammonium sulfate, ammonium hydroxide, urea-hydroxyapatite, amino acids such as arginine, cystine, histidine, leucine, lysine, methionine, threonine, tryptophan, tyrosine, valine, glutamine, glutamic acid, glycine, proline, taurine, aspartic acid, serine, alanine, and combinations thereof.

>95% particles may be in the spherical, nearly spherical shape or small linear fragments having size between 0.1 nm and 8 microns. (By TEM measurement). 0.1 nm and 10 microns with polydispersity index between 0.01 to 0.99 (by DLS measurement). Surface zeta potential ranged between +5 and 70 mV (measured by DLS).

Embodiments include methods of treating a plant or pant part with any of the compositions described herein. The plant part may be any plant part including, but not limited to a seed, leaf, stem, flower, fruit, or root of a plant. Examples species of plant parts include, but are not limited to, cereals such as wheat, corn or maize, barley, rye, oat; canola, cotton, eggplant, lettuce, sorghum, soybean, rice, oil seed rape, sugar beet, sugarcane, grapes, pulses lentils, sunflowers, alfalfa, citrus pome fruits; stone fruits; tree nuts, peanuts; coffee; tea; strawberries; turf; vegetables, such as tomatoes, potatoes, cucurbits, and lettuce.

Embodiments of methods of treating a plant or plant part may include adding a chitosan-based nanoparticle along with the application of a traditional agri-input or replacing all or a portion of a traditional agri-input. Replacement of an agri-input with a chitosan-based nanoparticle may replace between 0% and 100% of the total amount of the agri-input with a chitosan-based nanoparticle as described herein. In some embodiments, the percentage of agri-input being replaced is about 0, 1, 5, 10, 15, 20, 25, 30, 35, 40, 45, 50, 55, 60, 65, 70, 75, 80, 85, 90, 95, or 100. In some embodiments, the amount of nitrogen being replaced is 25%. In some embodiments, the agri-input being replaced is nitrogen. In some embodiments, the percentage of nitrogen being replaced is about 0, 1, 5, 10, 15, 20, 25, 30, 35, 40, 45, 50, 55, 60, 65, 70, 75, 80, 85, 90, 95, or 100. In some embodiments, the total nitrogen applied was reduced by about 25% with the addition of the chitosan-based nanoparticle formulation with a statistically equal yield. Another way of stating this is that the total amount of nitrogen used in the low nitrogen plus the chitosan-based nanoparticle was 75% of the nitrogen used in the high nitrogen with the same yield. Replacement of another agri-input with the chitosan-based nanoparticle begins with the removal of a percentage of the other agri-input. In some embodiments, the percentage of agri-input being removed is about 0, 1, 5, 10, 15, 20, 25, 30, 35, 40, 45, 50, 55, 60, 65, 70, 75, 80, 85, 90, 95, or 100 percent. In some embodiments, the agri-input being removed is nitrogen. In some embodiments, the percentage of nitrogen being removed is about 0, 1, 5, 10, 15, 20, 25, 30, 35, 40, 45, 50, 55, 60, 65, 70, 75, 80, 85, 90, 95, or 100 percent. In addition to the removal of an agri-input such as nitrogen, replacement of the agri-input such as nitrogen requires that an amount of nitrogen in the chitosan-based nanoparticle be added or applied to the plant or plant part. In some embodiments, the percentage of nitrogen in the chitosan-based nanoparticle to be added is about 0, 1, 2, 3, 4, 5, 5.5, 10, 15, 20, 25, 30, 35, 40, 45, or 50 of the amount of agri-input, such as nitrogen, which was removed. In some embodiments, the percentage of the chitosan-based nanoparticle to be added is about 5.5 percent of the amount of nitrogen removed.

Replacement of an agri-input with a chitosan-based nanoparticle may replace between 1% and 100% of the total amount of the agri-input with a chitosan-based nanoparticle. In some embodiments the agri-input is added to a hydroponic system. In some embodiments, the percentage of agri-input being replaced is about 1, 5, 10, 15, 20, 25, 30, 35, 40, 45, 50, 55, 60, 65, 70, 75, 80, 85, 90, 95, or 100. In some embodiments, the amount of agri-input being replaced is 70%. In some embodiments, the agri-input being replaced is nitrogen. In some embodiments, the percentage of nitrogen being replaced is about 1, 5, 10, 15, 20, 25, 30, 35, 40, 45, 50, 55, 60, 65, 70, 75, 80, 85, 90, 95, or 100. In some embodiments, the total nitrogen applied was reduced by about 70% with the addition of the chitosan-based nanoparticle formulation with a statistically equal biomass yield. Another way of stating this is that the total amount of nitrogen used in the low nitrogen plus the chitosan-based nanoparticle was 30% of the nitrogen used in the high nitrogen with the same yield. Replacement of another agri-input with the chitosan-based nanoparticle begins with the removal of a percentage of the other agri-input. In some embodiments, the percentage of agri-input being removed is about 0, 1, 5, 10, 15, 20, 25, 30, 35, 40, 45, 50, 55, 60, 65, 70, 75, 80, 85, 90, 95, or 100 percent. In some embodiments, the agri-input being removed is nitrogen. In some embodiments, the percentage of nitrogen being removed is about 0, 1, 5, 10, 15, 20, 25, 30, 35, 40, 45, 50, 55, 60, 65, 70, 75, 80, 85, 90, 95, or 100 percent. In some embodiments, the amount of nitrogen being removed is 70 percent. In addition to the removal of an agri-input such as nitrogen, replacement of the agri-input such as nitrogen requires that an amount of nitrogen in the chitosan-based nanoparticle be added or applied to the plant or plant part. In some embodiments, the percentage of nitrogen in the chitosan-based nanoparticle to be added is about 0, 1, 2, 3, 4, 5, 5.5, 10, 15, 20, 25, 30, 35, 40, 45, or 50 of the amount of agri-input, such as nitrogen, which was removed. In some embodiments, the percentage of the chitosan-based nanoparticle to be added is about 8.4 percent of the amount of nitrogen removed.

The replacement of the agri-input, such as nitrogen with the chitosan-based nanoparticles as described herein replaces a larger amount of agri-input, such as nitrogen with a smaller amount of the chitosan-based nanoparticle. Typically, a field has from 0 to 200 kg nitrogen applied to a corn field. The reduction in nitrogen may be between about 15 and 25 percent. In some embodiments, for example 88.5 kg/acre is reduced by 18.14 kg for a 20% reduction. In particular embodiments, for example, a corn field that is traditionally fertilized by amending 68.04 kg/acre of nitrogen, into the soil could be replaced by amending 49.90 kg/acre of nitrogen into the soil and spraying the plants with a chitosan-based nanoparticle sprayed at 5 l/acre. This is a 27% reduction in the total amount of nitrogen applied to the plants. In this embodiment, the plants which receive the chitosan-based nanoparticle spray grow the same or more than the plants which received the entire amount of nitrogen fertilizer.

In a second example, the chitosan-based nanoparticle solution is used in a hydroponic system. The nutrient addition is added to the hydroponic fluid. In a high nitrogen environment, nitrogen is added to the hydroponic solution so that each plant has an average of 105.50 mg N applied and the low nitrogen environment receives an average of 24.99 mg nitrogen per plant. The low nitrogen also receives 6.73+/−0.1 mg nitrogen per plant from a chitosan-based nanoparticle in a foliar spray. This is a removal of 76% of the hydroponic nitrogen, where 8.4% of the nitrogen removed is replaced with the chitosan-based nanoparticle via foliar application.

In certain embodiments, the chitosan-based nanoparticle is used in conjunction with a traditional nitrogen fertilizer. The chitosan-based nanoparticle is added on top of or along with a traditional nitrogen fertilizer. In one example the addition of chitosan-based nanoparticle compositions resulted in a 7% increase in yield percentage.

Several types of nitrogen agri-inputs are used, and the chitosan-based nanoparticle may replace any of them. When the composition, or the chitosan-based nanoparticle, is used to replace all or a part of an agri-input, such as nitrogen, the use of the chitosan-based nanoparticle results in yields that are statistically equal to or greater than the yield produced with traditional agri-inputs, such as nitrogen. The composition, or the chitosan-based nanoparticle, may be used in any type of growing environment. Growing environments include traditional agriculture with crops grown in the ground, in hydroponic systems, greenhouse, Controlled Environmental Agriculture (CEA), or in aquaponic systems. In some embodiments, the composition, or chitosan-based nanoparticle.

The chitosan-based nanoparticle may be applied to plants in any method used to administer agri-inputs, such as nitrogen. Application methods for field crops include soilapplied, sprays (e.g. foliar sprays), and injection into water. Soil applications are performed by mixing the chitosan-based nanoparticle into the soil in any one or combination of methods including broadcasting, top dressing, placement, drilling, side dressing, band placement, and pellet application. Foliar sprays place the chitosan-based nanoparticle on the foliage of growing plants. Some nutrients are readily absorbed by leaves, particularly when dissolved in water. Foliar sprays may be applied through handheld apparatus, backpack carried apparatus, sprayers, applicators, aerial application, such as from an airplane or Unmanned Aerial Vehicles (UAVs). The chitosan-based nanoparticle may also be applied through injection into a water source. This may be through irrigation systems, drip systems, or sprinkler systems. Application methods for hydroponic and/or aeroponic and/or geoponic systems include injection into the liquid and/or gel-based growth media, or foliar application through a spray or misting system.

The chitosan-based nanoparticle may be applied at any stage of soil preparation or plant growth. In some embodiments, the chitosan-based nanoparticle may be applied at the emergent stage. In some embodiments, the chitosan-based nanoparticle may be applied to a plant part at any point during the vegetative stage of plant growth. In some embodiments, the chitosan-based nanoparticle may be applied to a plant part at the reproductive stage of plant growth. In some embodiments, the chitosan-based nanoparticle may be applied to seed coatings. In embodiments, the chitosan-based nanoparticle is applied to the soil prior to planting. In some embodiments, the chitosan-based nanoparticle is applied to the soil during the growing stage. In some embodiments, the chitosan-based nanoparticle is applied to the soil during the maturation stage. In some embodiments, the chitosan-based nanoparticle is applied to the soil during the dormancy stage. In some embodiments, the chitosan-based nanoparticle is applied at any combination of the foregoing. In one embodiment the chitosan-based nanoparticle is applied is applied at least at two different time points. In one embodiment the chitosan-based nanoparticle is applied is applied at least at three different time points. In one embodiment the chitosan-based nanoparticle is applied is applied at least at four different time points. In one embodiment the chitosan-based nanoparticle is applied is applied at least at five different time points. In one embodiment the chitosan-based nanoparticle is applied is applied at least at six different time points. Further embodiments include using the chitosan-based nanoparticle in combination with other agri-inputs. Such agri-inputs include primary macronutrients such as nitrogen, phosphorus, and potassium; secondary macronutrients such as calcium, magnesium, and sulfur; Micronutrients such as iron, zinc, copper, manganese, and boron; herbicides; insecticides; fungicides; nematicides; plant growth regulators (PGRs) such as auxins, cytokinins, gibberellins, and ethylene; and seed treatments.

Further embodiments include methods of treating a plant growth medium with any of the compositions described herein. Plant growth medium may comprise one or more of soil, peat, moss, wood residue, leaf mold, sawdust, bark, bagasse, rice hull, sand, perlite, vermiculite, calcinated clay, polystyrene, urea formaldehyde resins, agar, or agarose, in vitro and in vivo plant tissue culture/growth medium and hydroponic liquids and substances used for aeroponic and geoponics. Methods of treating plant growth media may include soil amendments, additions to solid media, or additions to liquid media such as that found in hydroponic systems.

A first embodiment provides a composition comprising: chitosan and at least 1% (w/w) nitrogen.

In a second embodiment, the composition of embodiment 1 has the nitrogen at between about 11% (w/w) and about 25% (w/w).

In a third embodiment, the composition of embodiment 1 has at least 50% of the nitrogen in the chemical form of amine and/or nitrate and/or ammonia.

In a fourth embodiment, the composition of embodiment 3 comprises a nanoparticle of chitosan and a nitrogen rich compound and/or mixture of compounds selected from the group consisting of potassium nitrate, calcium nitrate, magnesium nitrate, urea nitrate, urea ammonia nitrate, ammonium nitrate, ammonium hydroxide, ammonium sulfate, urea-hydroxyapatite, amino acids such as arginine, cystine, histidine, leucine, lysine, methionine, threonine, tryptophan, tyrosine, valine, glutamine, glutamic acid, glycine, proline, taurine, aspartic acid, serine and alanine.

In a fifth embodiment, the composition of embodiment 1 has the chitosan present at between about 0.01% and about 4% (w/v).

In a sixth embodiment, the composition of embodiment 1 and the addition of a coupling enhancer.

In a seventh embodiment, the composition of embodiment 6 where the coupling enhancer is sodium tripolyphosphate and/or ammonium sulfate.

An eighth embodiment is a method of producing chitosan nanoparticles. The method includes dissolving chitosan in acidic water. Where the water is made acidic by an acid selected from the group of acetic acid, nitric acid, sulfuric acid, hydrochloric acid, and combinations thereof. Nanoparticles are formed from the dissolved chitosan.

In a ninth embodiment, the method according to embodiment 8 where a coupling enhancer is added to the dissolved chitosan.

In a tenth embodiment, the method according to embodiment 9 where the coupling enhancer is sodium tripolyphosphate and/or ammonium sulfate.

In an eleventh embodiment, the method according to embodiment 8 where the nitrogen rich compound and/or mixture of compounds is selected from the group consisting of potassium nitrate, calcium nitrate, magnesium nitrate, urea nitrate, urea ammonia nitrate, ammonium nitrate, ammonium sulfate, urea-hydroxyapatite, amino acids such as arginine, cystine, histidine, leucine, lysine, methionine, threonine, tryptophan, tyrosine, valine, glutamine, glutamic acid, glycine, proline, taurine, aspartic acid, serine and alanine is/are added the dissolved chitosan.

In a twelfth embodiment, the method according to embodiment 11 where the nanoparticles comprise chitosan and nitrogen rich compound and/or mixture of compounds.

In a thirteenth embodiment, the method according to embodiment 12, where the nanoparticles comprise at least 1% (w/w) nitrogen.

In a fourteenth embodiment, the method according to embodiment 13, where the nitrogen is present at between about 11% (w/w) and about 25% (w/w).

In a fifteenth embodiment, the method according to embodiment 11, where the chitosan is present at between about 0.01% and about 4% (w/v).

A sixteenth embodiment is a method of treating a plant or a plant part, the method comprising treating the plant or plant part with a composition according to any of embodiments 1-7.

In a seventeenth embodiment, the method according to embodiment 16 where the plant part is selected from the group consisting of a seed, leaf, stem, flower, or root of a plant.

In an eighteenth embodiment, the method according to embodiment 17 is practiced where a predetermined amount of the composition according to any of claims 1-7 is used in place of a predetermined amount of a traditional fertilizer and produces an equal or better yield.

In a nineteenth embodiment, the method according to embodiment 18 is practiced where a predetermined amount of the composition according to any of claims 1-7 is between about 250 mL per acre and about 30 liters per acre applied in a foliar spray and is used in place of between about 0 kilograms per acre and about 150 kilograms per acre of nitrogen units applied via traditional nitrogen fertilizer.

In a twentieth embodiment, the method according to claim 19 is practiced where the predetermined amount of the composition according to any of claims 1-7 is about 5 liters per acre applied in a foliar spray and is used in place of about 18.14 kilograms per acre traditional nitrogen fertilizer.

A twenty-first embodiment is a method of preparing a plant growth medium where the method comprises treating the growth medium with a composition according to any of embodiments 1-7.

In a twenty-second embodiment, the method according to embodiment 18, where the growth medium is soil, peat, moss, wood residue, leaf mold, sawdust, bark, bagasse, rice hull, sand, perlite, vermiculite, calcinated clay, polystyrene, urea formaldehyde resins, and hydroponic liquids, and combinations thereof.

In a twenty-third embodiment, the method according to embodiment 18 where the percentage of the composition used is between about 4 percent and about 12 percent of the traditional nitrogen fertilizer removed.

In a twenty-fourth embodiment, the method according to embodiment 25 where the percentage of the composition used is about 8.4 percent of the traditional nitrogen fertilizer removed.

In a twenty-fifth embodiment, the method according to embodiment 18 where the total nitrogen used is reduced by between about 0 percent and about 80 percent.

In a twenty-sixth embodiment, the method according to embodiment 25 where the total nitrogen used is reduced by about 70 percent.

In a twenty-seventh embodiment, the method of claim 25 where the total nitrogen used is reduced by about 76 percent.

In a twenty-eighth embodiment, a chitosan-based nanoparticle is added along with a standard amount of traditional fertilizer.

In a twenty-ninth embodiment, the chitosan-based nanoparticle of embodiment 28 results in an improvement in yield of between about 0% and about 80%.

In a thirtieth embodiment, the chitosan-based nanoparticle of embodiment 29 results in an improvement in yield of about 7%.

### Example 1

### Preparation of Chitosan Using Various Acids

[Acetic Acid] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, acetic acid between 0.3% and 1.9% (v/v) was added. The temperature and agitation was maintained constantly throughout the reaction for up to 4 hours. At the end, when the flakes became invisible to the solution, it was filtered with 200 mesh followed by <635 mesh filtration unit. The solution temperature was cooled down to 77-degree F., and a solution of potassium sorbate was added (0.01-1% v/v) and mixed well using agitation.

[Acetic Acid+NaTPP] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, acetic acid between 0.3% and 1.9% (v/v) was added. When the flakes became invisible to the solution, a solution of sodium tripolyphosphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Acetic Acid+Ammonium Sulphate] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, acetic acid between 0.3% and 1.9% (v/v) was added. When the flakes became invisible to the solution, a solution of Ammonium Sulphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Nitric Acid+Acetic Acid] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, acetic acid and nitric acid having a ratio of 1:1, 1:2, 2:1 and a total v/v acid strength between 0.3% and 1.9% was added. The temperature and agitation were maintained constantly throughout the reaction for up to 4 hours. At the end, when the flakes became invisible to the solution, it was filtered with 200 mesh followed by <635 mesh filtration unit. The solution temperature was cooled down to 77-degree F., and a solution of potassium sorbate was added (1% v/v) and mixed well using agitation.

[Nitric Acid+Acetic Acid+NaTPP] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, acetic acid and nitric acid having a ratio of 1:1, 1:2, 2:1 and a total v/v acid strength between 0.3% and 1.9% was added. When the flakes became invisible to the solution, a solution of sodium tripolyphosphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Nitric Acid+Acetic Acid+Ammonium Sulphate] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, acetic acid and nitric acid having a ratio of 1:1, 1:2, 2:1 and a total v/v acid strength between 0.3% and 1.9% was added. When the flakes became invisible to the solution, a solution of ammonium sulphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Nitric Acid+NaTPP] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, nitric acid between 0.3% and 1.9% (v/v) was added. When the flakes became invisible to the solution, a solution of sodium tripolyphosphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Nitric Acid+Ammonium sulphate] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, nitric acid between 0.3% and 1.9% (v/v) was added. When the flakes became invisible to the solution, a solution of ammonium sulphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Nitric Acid] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, nitric acid between 0.3% and 1.9% (v/v) was added. The temperature and agitation were maintained constantly throughout the reaction for up to 4 hours. At the end, when the flakes became invisible to the solution, it was filtered with 200 mesh followed by <635 mesh filtration unit. The solution temperature was cooled down to 77-degree F., and a solution of potassium sorbate was added (0.01-1% v/v) and mixed well using agitation.

[Hydrochloric Acid] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, hydrochloric acid between 0.3% and 1.9% (v/v) was added. The temperature and agitation were maintained constantly throughout the reaction for up to 4 hours. At the end, when the flakes became invisible to the solution, it was filtered with 200 mesh followed by <635 mesh filtration unit. The solution temperature was cooled down to 77-degree F., and a solution of potassium sorbate was added (0.01-1% v/v) and mixed well using agitation.

[Hydrochloric Acid+NaTPP] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, hydrochloric acid between 0.3% and 1.9% (v/v) was added. When the flakes became invisible to the solution, a solution of sodium tripolyphosphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Hydrochloric Acid+Ammonium sulphate] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, hydrochloric acid between 0.3% and 1.9% (v/v) was added. When the flakes became invisible to the solution, a solution of ammonium sulphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Sulfuric Acid] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, sulfuric acid between 0.3% and 1.9% (v/v) was added. The temperature and agitation were maintained constantly throughout the reaction for up to 4 hours. At the end, when the flakes became invisible to the solution, it was filtered with 200 mesh followed by <635 mesh filtration unit. The solution temperature was cooled down to 77-degree F., and a solution of potassium sorbate was added (0.01-1% v/v) and mixed well using agitation.

[Sulfuric Acid+NaTPP] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, sulfuric acid between 0.3% and 1.9% (v/v) was added. When the flakes became invisible to the solution, a solution of sodium tripolyphosphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Sulfuric Acid+Ammonium Sulphate] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, sulfuric acid between 0.3% and 1.9% (v/v) was added. When the flakes became invisible to the solution, a solution of ammonium sulphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Nitric Acid+Acetic Acid+Hydrochloric Acid+Sulfuric Acid] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, acetic acid, nitric acid, hydrochloric acid, sulfuric acid having a ratio of 1:1:0:0, 1:0:1:0, 1:0:0:1, 1:1:1:0, 1:1:2:0, 1:1:1:1, 1:1:1:2 and a total v/v acid strength between 0.3% and 1.9% was added. The temperature and agitation were maintained constantly throughout the reaction for up to 4 hours. At the end, when the flakes became invisible to the solution, it was filtered with 200 mesh followed by <635 mesh filtration unit. The solution temperature was cooled down to 77-degree F., and a solution of potassium sorbate was added (1% v/v) and mixed well using agitation.

[Nitric Acid+Acetic Acid+Hydrochloric Acid+Sulfuric Acid+NaTPP] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, acetic acid, nitric acid, hydrochloric acid, sulfuric acid having a ratio of 1:1:0:0, 1:0:1:0, 1:0:0:1, 1:1:1:0, 1:1:2:0, 1:1:1:1, 1:1:1:2 and a total v/v acid strength between 0.3% and 1.9% was added. When the flakes became invisible to the solution, a solution of sodium tripolyphosphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

[Nitric Acid+Acetic Acid+Hydrochloric Acid+Sulfuric Acid+Ammonium Sulphate] A germ free or autoclaved water was charged to the tank having agitation speed of 400 rpm. When the temperature reaches between 68- and 194-degrees F., chitosan flakes (0.1-5% w/v) having 80% DDA but not less than 75% DDA were added. The source of chitosan can be fungus, shrimp, crab or lobster or a mixture of them. Furthermore, the chitosan variants can be alpha, beta or gamma or a mixture of them. Following the soaking of the flakes with water, acetic acid, nitric acid, hydrochloric acid, sulfuric acid having a ratio of 1:1:0:0, 1:0:1:0, 1:0:0:1, 1:1:1:0, 1:1:2:0, 1:1:1:1, 1:1:1:2 and a total v/v acid strength between 0.3% and 1.9% was added. When the flakes became invisible to the solution, a solution of ammonium sulphate (0.001-1% v/v or v/w) was added. The temperature and agitation were maintained constantly throughout the reaction for up to 4 hours. At the end, the solution was filtered with 200 mesh followed by <635 mesh filtration unit. The solution temperature was cooled down to 77-degree F., and a solution of potassium sorbate was added (0.01-1% v/v) and mixed well using agitation.

### Example 2

Various of the above chitosan solutions were prepared using chitosan from two different sources. These sources are designated Tg and CTg. Tg and CTg were used to create chitosan-based nanoparticles using the above identified procedures to yield the following products.
TgA=Tg source chitosan-based nanoparticles prepared with acetic acid.
TgB=Tg source chitosan-based nanoparticles prepared with acetic acid and sodium tripolyphosphate.
TgC=Tg source chitosan-based nanoparticles prepared with acetic acid and nitric acid.
TgD=Tg source chitosan-based nanoparticles prepared with acetic acid, nitric acid, and sodium tripolyphosphate.
TgE=Tg source chitosan-based nanoparticles prepared with nitric acid and sodium tripolyphosphate.
CTgA=CTg source chitosan-based nanoparticles prepared with acetic acid.
CTgB=CTg source chitosan-based nanoparticles prepared with acetic acid and sodium tripolyphosphate.
CTgC=CTg source chitosan-based nanoparticles prepared with acetic acid and nitric acid.
CTgD=CTg source chitosan-based nanoparticles prepared with acetic acid, nitric acid, and sodium tripolyphosphate.
CTgE=CTg source chitosan-based nanoparticles prepared with nitric acid and sodium tripolyphosphate.

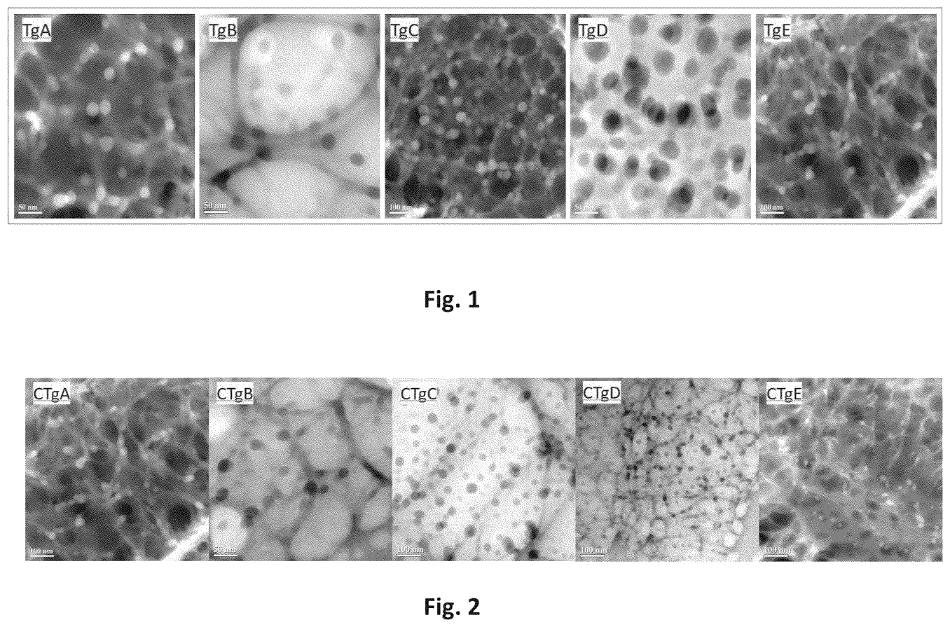

The formulation and intermediates were characterized for the physicochemical characterizations. The physical morphology (shape and size) was characterized using the transmission or scanning electron microscope (FIGS. 1 and 2). Resultant solution/s obtained for the Tg sourced chitosan had >95% particles were in the spherical, nearly spherical shape or small linear fragments having size between 0.1 nm and 5 microns. More specifically, the desired size obtained and utilized for further formulation development was less than 0.5 micron was used for further formulation development and/or other agricultural use for crop growth, stimulation, germination, and trait improvement purpose. Similarly, resultant solution obtained for the CTg sourced chitosan had the physical structure as spherical shape and size ranges between 0.1 nm and 8 microns. More specifically the size obtained between 0.1 nm and 200 nm was used as a selection parameter for the delivery to the crop for growth, stimulation, germination, and trait improvement purposes.

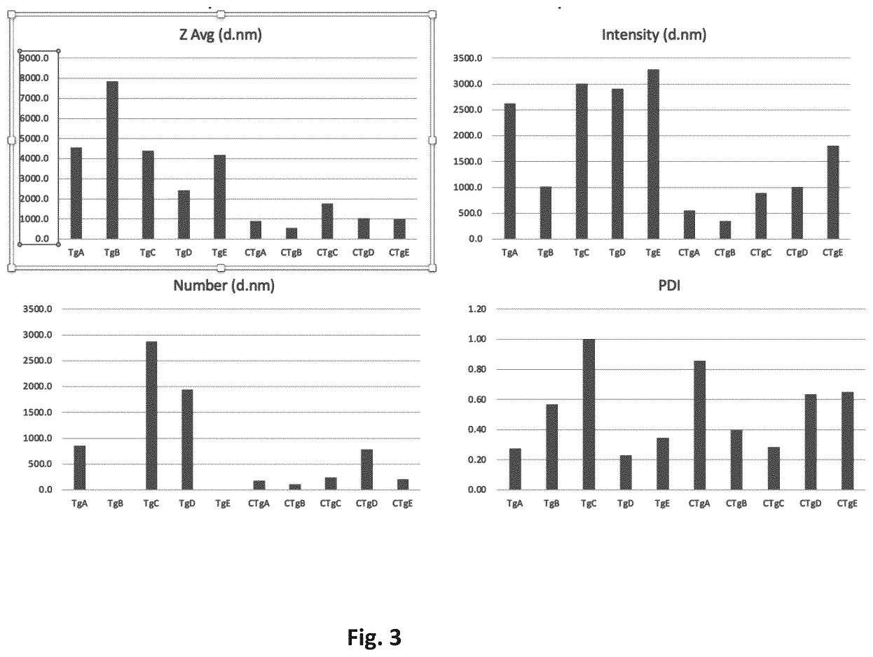

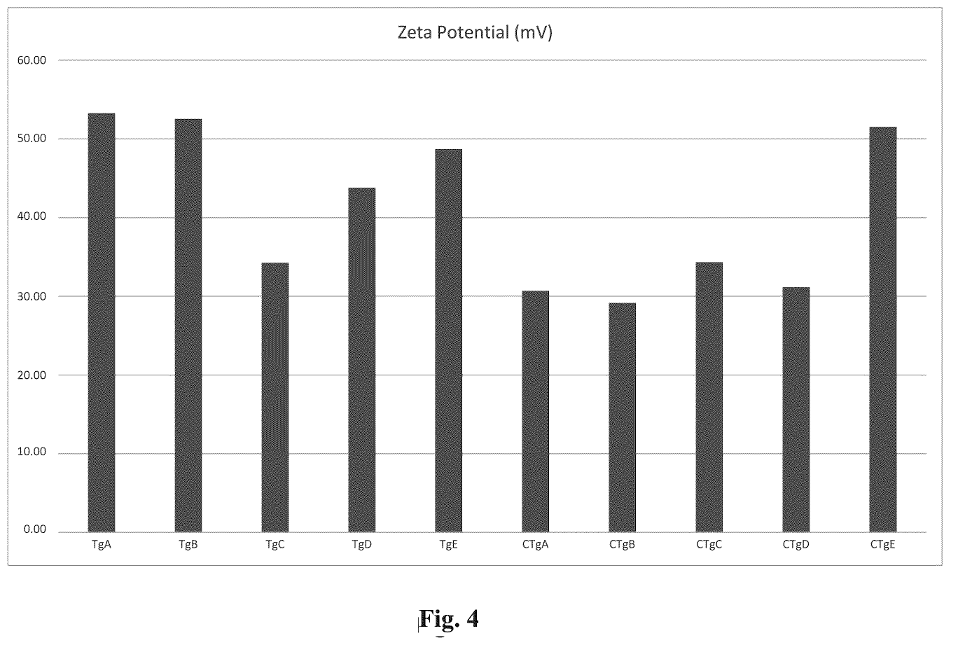

The dynamic stability and hydrodynamic size in the solution was characterized using the dynamic light scattering or DLS the nanoparticles were subjected to dynamic light scattering (DLS) and analyzed for Z average, Intensity, Number, and Polydispersity (PDI) (FIG. 3). Resultant solutions had ranges between 0.1 nm and 10 microns with polydispersity index between 0.01 to 0.99. Furthermore, the surface zeta potential of the resultant solutions characterized by DLS (FIG. 4), and it ranged between +5 and 70 mV. The major determinant factor for zeta potential was chitosan concentration and pH of the solution. Higher chitosan concentration and lower pH yielded higher zeta potential.

### Example 3

The ability of the various chitosan-based nanoparticles generated in Examples 1 and 2 to load nitrogen and/or nitrogen rich compound and/or mixture of compounds such as but not limited to potassium nitrate, calcium nitrate, magnesium nitrate, urea nitrate, urea, urea ammonia nitrate, ammonium nitrate, ammonium sulfate, ammonium hydroxide, Urea-hydroxyapatite, amino acids such as arginine, cystine, histidine, leucine, lysine, methionine, threonine, tryptophan, tyrosine, valine, glutamine, glutamic acid, glycine, proline, taurine, aspartic acid, serine and alanine was tested. Association and slow release of nutrients is one method for balancing the nutritional needs of plants. Several solutions were prepared and evaluated.

### Preparation of Chitosan Solutions

### Preparation for Solution A: Chitosan Solution in Acetic Acid

Step 1. Take 150 ml water in a 250 ml beaker. Step 2. Turn on Top head stirrer at room temperature at 300 RPM. The stirrer was continuously ON through the process until it says stirrer STOP. Step 3. After 3 minutes of step 2, Add 8-gram chitosan flake. Step 4. After 7 minutes of step 3, Add 8 mL of 99.7% Glacial Acetic Acid. Step 5. After complete dissolution of the flake (after 17 minutes after step 4), add 50 mL water. Step 6. After 10 minutes of step 5, The stirrer stopped. Step 7. Filter the solution with 200 mesh size filter. The total volume of the solution was 210 mL and 104.335 g/100 mL. The calculated % of the Chitosan of the solution is 3.8% (w/v). The pH of the solution is 3.88.

### Preparation for Solution B: Chitosan Solution in HCL

Step 1. Take 150 ml water in a 250 ml beaker. Step 2. Turn on Top head stirrer at room temperature at 300 RPM. The stirrer was continuously ON through the process until it says stirrer STOP. Step 3 After 3 minutes of step 2, Add 8-gram chitosan flake. Step 4. After 7 minutes of step 3, Add 8 mL of 35.4% HCL. Step 5. After complete dissolution of the flake (after 85 minutes after step 4), add 50 mL water. Step 6. After 26 minutes of the step 5, The stirrer stopped. Step 7. Filter the solution with 200 mesh size filter. The total volume of the solution in mL was 222.096 mL at 105.37 Gram/100 mL. The calculated % CS of the solution was 3.6% (w/v) with a pH of the solution at 0.66.

### Preparation for Solution C: Chitosan Solution in Nitric Acid

Step 1. Take 800 ml water in a 2000 mL beaker. Step 2. Turn on Top head stirrer at room temperature at 600 RPM. The stirrer was continuously ON through the process until it says stirrer STOP. Step 3. After 2 minutes of step 2, Add 20 gram chitosan flake. Step 4. After 5 minutes of the step 3, Add 20 mL of 69.71% Nitric Acid. Step 5. After complete dissolution of the flake (after 110 minutes after step 4), add 100 mL water. Step 6. After 14 minutes of the step 5, The stirrer stopped. Step 7. After 10 minutes of step 6, add 80 ml of water to make up the solution to 1000 mL. Step 8. Filter the solution with 200 mesh size filter. The total volume of the solution in mL was 1000 mL at 100.686 Gram/100 mL. The calculated % CS of the solution is 2% (w/v) with a pH of the solution at 0.84.

### Preparation for Solution D: Chitosan Solution in Acetic Acid

Step 1. Take 800 ml water in a 2000 mL beaker. Step 2. Turn on Top head stirrer at room temperature at 600 RPM. The stirrer was continuously ON through the process until it says stirrer STOP. Step 3. After 4 minutes of step 2, Add 20 gram chitosan flake. Step 4. After 10 minutes of the step 3, Add 20 mL of 99.7% Glacial Acetic Acid. Step 5. After complete dissolution of the flake (after 10 minutes after step 4). Step 6. After 17 minutes of the step 5, The stirrer was stopped. Step 7. After 10 minutes of step 6, Add water 180 ml to make up the solution to 1000 mL. Step 8. Filter the solution with 200 mesh size filter. The total volume of the solution in mL was 1000 ML at 100.472 Gram/100 mL. The calculated % CS of the solution was 2% (w/v) with a pH of the solution at 3.91.

Preparation for Solution E: Chitosan Solution in H₂SO₄

The H₂SO₄ solution did not work, as the chitosan did not dissolve in solution, this effectively terminated the experiment, and the H₂SO₄ solution was not used in any association production.

### Preparation for Solution F: Chitosan Solution in HCL

Step 1. Take 800 ml water in a 2000 mL beaker. Step 2. Turn on Top head stirrer at room temperature at 600 RPM. The stirrer was continuously ON through the process until it says stirrer STOP. Step 3. After 2 minutes of step 2, Add 20 gram chitosan flake. Step 4. After 6 minutes of the step 3, Add 20 mL of 35.4% HCL. Step 5. After complete dissolution of the flake (after 44 minutes after step 4), add 100 mL water. Step 6. After 12 minutes of the step 5, The stirrer stopped. Step 7. After 10 minutes of the step 6, Added 80 mL water to make up to 1000 mL and mixed thoroughly. Step 8. Filter the solution with 200 mesh size filter. The total volume of the solution in mL was 1000 mL at 100.328 Gram/100 mL. The calculated % CS of the solution was 2% (w/v) with a pH of the solution at 1.09.

### Preparation of Coupling Enhancer-Ammonium Sulphate (AS) Solution

Step 1. Take 0.200 gram ammonium sulphate in 50 mL capacity volumetric flask. Step 2. Add 30 mL water. Step 3. Vortex the solution-resultant solution becomes clear. Step 4. Make up the volume to 50 mL using 20 mL water. The total volume of the solution in mL was 50 mL; 49.764 g. The calculated % AS of the solution was 0.4% w/v. The calculated N % of the solution was 0.0856% w/v. The calculated S % of the solution was 0.0980% w/v. The pH of the solution was 5.75.

### Preparation of Coupling Enhancer—Tri Sodium Polyphosphate (TPP) Solution

Step 1. Take 0.200 gram in 50 mL capacity volumetric flask. Step 2. Add 30 mL water. Step 3. Vortex the solution-resultant solution becomes clear. Step 4. Make up the volume to 50 mL using 20 mL of water. The total volume of the solution in mL was 50 mL: 49.821 g. The calculated % TP of the solution was 0.4% w/v. The calculated P % of the solution was 0.101%. The pH of the solution was 9.76.

### Formulation of the Associated Urea

### Chitosan-Based Nanoparticle #1

Step 1. Take a 2000 mL beaker. Step 2. Add 175 mL solution A. Step 3. Start over head stirrer, it was continued through the process until it says stop. Step 4. After 5 minutes of step 3, add 100 mL water. Step 5. After 6 minutes of step 4, add 100 gram urea. Step 6. After 13 minutes of step 5, add 100 gram urea. Step 7. After 1 minute of step 6, add 50 mL water. Step 8. After 8 minutes of step 7, add 50 mL water. Step 9. After 10 minutes of step 8, add 135 gram urea. Step 10. After 9 minutes of step 9, add 175 solution B. Step 11. After 18 minutes of step 10, add 25 mL water. Step 12. After 52 minutes of step 11, add 10 mL Ammonium sulphate solution (0.1 gram in 10 mL or 1% w/v). Step 12. After 15 minutes of step 12, the stirrer was stopped. The solution makes up to 1000 mL using 125 mL water. Step 13. Filter the solution with 200 mesh size filter. Step 14. Solution is ready for further use/QC testing analyses, stored in 1 L bottle. The method resulted in chitosan association of the nutrients, with the solution having Urea: 43.5% (w/v), N % w/v: 20.01 (calculated); 18.24% (analyzed by TKN), Ammonium sulphate: 0.01 (w/v), Chitosan: 1.29% (w/v), Acetic Acid: 0.7% (v/v), HCl: 0.7% (v/v), pH: 3.67. Weight (Gram/100 mL): 110.832 Gram

### Chitosan-Based Nanoparticle #2

Step 1. Take a 2000 mL beaker. Step 2. Add 200 mL solution D. Step 3. Started over head stirrer, it was continued through the process until it says stop. Step 4. After 3 minutes of step 3, add 200 mL distil water. Step 5. After 5 minutes of step 4, add 100 gram urea. Step 6. After 7 minutes of step 5, add 100 gram urea. Step 7. After 5 minutes of step 6, add 100 gram urea. Step 8. After 8 minutes of step 7, add 135 gram urea. Step 9. After 10 minutes of step 8, add 100 solution F. Step 10. After 13 minutes of step 9, add 100 solution F. Step 11. After 19 minutes of step 10, add 75 mL water. Step 12. After 5 minutes of step 11, add 25 mL Ammonium sulphate solution (0.1 gram in 25 mL water or 0.4% w/v). Step 13. After 15 minutes of step 12, the stirrer was stopped. The solution was 1 L. Step 14. Filter the solution with 200 mesh size filter. Step 15. Solution is ready for further use/QC testing analyses, stored in 1 L bottle. This example of the method resulted in chitosan association of the nutrients, with the solution having, Urea: 43.5% (w/v), N % w/v: 20.01 (calculated); 18.05 (analyzed by TKN), Ammonium sulphate: 0.01 (w/v), Chitosan: 0.8% (w/v), Acetic Acid: 0.4% (v/v), HCl Acid: 0.4% (v/v), pH: 4, and a Weight (gram/100 mL): 110.622 gram.

### Chitosan-Based Nanoparticle #3

Step 1. Take a 2000 mL beaker. Step 2. Add 200 ml of water. Step 3. Started over head stirrer, it was continued through the process until it says stop. Step 4. After 2 minutes of step 3, add 200 mL solution D. Step 5. After 5 minutes of step 4, add 100 gram urea. Step 6. After 3 minutes of step 5, add 100 gram urea. Step 7. After 6 minutes of step 6, add 100 gram urea. Step 8. After 11 minutes of step 7, add 135 gram urea. Step 9. After 10 minutes of step 8, add 200 solution C. Step 10. After 50 minutes of step 9, add Ammonium sulphate solution (0.1 gram in 25 mL water or 0.4% w/v). Step 11. After 35 minutes of step 10, stirrer was stopped. The solution was made up to 1000 mL, by adding 60 mL water. Step 12. Filter the solution with 200 mesh size filter. Step 13. Solution is ready for further use/QC testing analyses, stored in 1 L bottle. This example of the method resulted in chitosan association of the nutrients, with the solution having; Urea: 43.5% (w/v), N % w/v: 20.1 (calculated); 18.17 (analyzed by TKN), Ammonium sulphate: 0.01% (w/v), Chitosan: 0.8% (w/v), Acetic Acid: 0.4 (v/v), Nitric Acid: 0.4 (v/v), a pH: 3.22, and a Weight (gram/100 mL): 110.622 gram.

### Chitosan-Based Nanoparticle #4

Step 1. Take a 1000 mL beaker. Step 2 Add 300 mL water. Step 3. Start magnetic stirrer, it was continued through the process until it says stop. Step 4. After 07 minutes of step 3, add 100 gram urea. Step 5. After 4 minutes of step 4, add 100 gram urea. Step 6. After 2 minutes of step 5, add 100 gram urea. Step 7. After 4 minutes of step 6, add 135 gram urea. Step 8. After 15 minutes of step 7 (solution was not completely dissolved like semi crystals appearing bottom of the beaker), and stirrer stop. Step 9. After step 8, Take another separate 2 L beaker and add 200 mL solution C and start overhead stirrer. Step 10. After 2 minutes of step 9, add semi dissolve solution of urea (prepared in step 7) transfer into solution C. Step 11. After 3 minutes of step 10, add 100 mL water. Step 12. After 17 minutes of step 11, add 50 mL water. Step 13. After 8 minutes of step 12, add ammonium sulphate solution (0.1 gram in 25 mL water or 0.4% w/v). Step 14. After 25 minutes of step 13, stirrer was stopped. The solution was made up to 1000 mL for that 25 mL water was added. Step 15. Filter the solution with 200 mesh size filter. Step 16. Solution is ready for further use/QC testing analyses, stored in 1 L bottle. This example of the method resulted in chitosan association of the nutrients, with the solution having; Urea: 43.5% (w/v), N % w/v: 20.01 (calculated); 18.42 (analyzed by TKN), Ammonium sulphate: 0.01 (w/v), Chitosan: 0.4% (w/v) Nitric Acid: 0.4% (v/v), pH: 2.87, and Weight (gram/100 mL): 110.586 gram.

### Chitosan-Based Nanoparticle #5

Step 1. Take a 2000 mL beaker. Step 2. Add 200 mL solution D. Step 3. Started over head stirrer, it was continued through the process until it says stop. Step 4. After 2 minutes of step 3, add 200 mL water. Step 5. After 4 minutes of step 4, add 100 gram urea. Step 6. After 4 minutes of step 5, add 100 gram urea. Step 7. After 12 minutes of step 6, add 100 gram urea. Step 8. After 11 minutes of step 7, add 135 gram urea. Step 9. After 13 minutes of step 8, add 200 solution C. Step 10. After 25 minutes of step 9, add TPP solution (0.1 gram TPP in 25 mL water or 0.4% w/v). Step 11. After 20 minutes of step 10, stirrer was stopped. The solution was made up to 1000 mL by adding 80 mL water. Step 12. Filter the solution with 200 mesh size filter. This example of the method resulted in chitosan association of the nutrients, with the solution having; Urea: 43.5% (w/v), N % w/v: 20.01 (calculated); 18.06 (analyzed by TKN), TPP: 0.01% (w/v), Chitosan: 0.8% (w/v), Acetic Acid: 0.4% (v/v), Nitric Acid: 0.4% (v/v), pH: 3.14, and a Weight (gram/100 mL): 110.726 gram.

### Chitosan-Based Nanoparticle #6

Step 1. Take a 1000 ml beaker. Step 2. Add 400 mL water. Step 3. Started magnetic (bottom head) stirrer, it was continued through the process until it says stop. Step 4. After 5 minutes of step 3, add 100 gram urea. Step 5. After 9 minutes of step 4, add 100-gram urea. Step 6. After 4 minutes of step 5, add 100 gram urea. Step 7. After 12 minutes of step 6, add 135 gram urea. Step 8. After 30 minutes of step 7 (solution was not completely dissolved, crystals were appearing at bottom of the beaker), and stirrer stop. Step 9. Take another separate 2 L volume beaker and add 200 mL solution C. The overhead stirrer was started. Step 10. After 4 minutes of step 9, add urea semi dissolve solution (prepared in step 7) transfer into solution C. Step 11. Step 12. After 1 minute of step 10, add 50 mL water. Step 13. After 15 minutes of step 11, add TPP solution (0.1 gram in 25 mL water or 0.4% w/v). Step 14. After 20 minutes of step 12, the stirrer was stopped. Step 15. The solution was made up to 1000 mL by adding 25 mL water. Step 16. Filter the solution with 200 mesh size filter. This example of the method resulted in chitosan association of the nutrients, with the solution having; Urea: 43.5% (w/v), N % w/v: 20.01 (calculated); 17.9 (analyzed by TKN), TPP: 0.01% (w/v), Chitosan: 0.4% (w/v), Nitric Acid: 0.4% (v/v), pH 2.88, Weight (gram/100 mL): 110.506 gram.

### Chitosan-Based Nanoparticle #7

Step 1. Take a 1000 mL beaker. Step 2. Add 400 mL water. Step 3. Start magnetic stirrer, it was continued through the process until it says stop. Step 4. After 5 minutes of step 3, add 100 gram urea. Step 5. After 10 minutes of step 4, add 100 gram urea. Step 6. After 20 minutes of step 5, add 100 gram urea. Step 7. After 10 minutes of step 6, add 135 gram urea. Step 8. After 305 minutes of step 7 (solution was not completely dissolved like semi crystals appearing bottom of the beaker), and stirrer stop. Step 9. Take another separate 2 L beaker and add 200 mL solution D and start overhead stirrer. Step 10. After 2 minutes of step 9, add urea semi dissolve solution (prepared in step 8) transfer into solution D. Step 11. After 3 minutes of step 10, add 25 mL water. Step 12. After 11 minutes of step 11, add ammonium sulphate solution (0.1 gram in 25 mL water or 0.4% w/v). Step 13. After 26 minutes of step 12, stirrer was stopped, and the solution was made up to 1000 mL by adding 50 mL water. Step 14. Filter the solution with 200 mesh size filter. This example of the method resulted in chitosan association of the nutrients, with the solution having; Urea: 43.5% (w/v), N % w/v: 20.01 (calculated); 18.19 (analyzed by TKN), Ammonium sulphate: 0.01% (w/v), Chitosan: 0.4% (w/v), Acetic Acid: 0.4% (v/v), pH: 4.76, and Weight (gram/100 mL): 110.29 gram.

Coupling agent—such as Glutaraldehyde, Genipin, Epichlorohydrin, Tripolyphosphate or sodium tripolyphosphate, Sodium Hexametaphosphate, Polyphosphates. Sufates such as ammonium sulphate, dextran Sulfate, Ethylenediamine, Tartaric Acid, Urea, sodium trimetaphosphate are chemical agents or compounds that facilitate the association between chitosan molecules, resulting in the creation of a three-dimensional network or structure can be used along or in combination with chitosan and chitosan containing nitrogen nanoparticles.

Stability agent: The potential adjuvants/stability agent include-Surfactants: Non-ionic surfactants (e.g., alkyl polyglucosides), Anionic surfactants (e.g., alkyl sulfonates), Cationic surfactants (e.g., alkylamines) Emulsifiers: Polyethylene glycol (PEG) derivatives Sorbitan esters (e.g., Tween series) Spreaders/Stickers: Organosilicone surfactants, Fatty acid-based spreaders (e.g., methylated seed oils), Penetrants: Crop oil concentrates, Methylated seed oils. Buffering Agents: Ammonium sulfate, Potassium dihydrogen phosphate, Compatibility Agents: Polyvinyl alcohol, Polyacrylic acid; Antifoaming Agents: Silicone-based antifoams, Polyethylene glycol-based antifoams; pH Adjusters: Ammonium hydroxide, phosphoric acid, sodium hydroxide, Citric acid; Thickeners: Guar gum, Acacia gum, Xanthan gum; Humectants: Glycerol, Propylene glycol can be used with chitosan solution, chitosan nanoparticle and chitosan, nitrogen combination for enhancing its stability and improving delivery to plants parts.

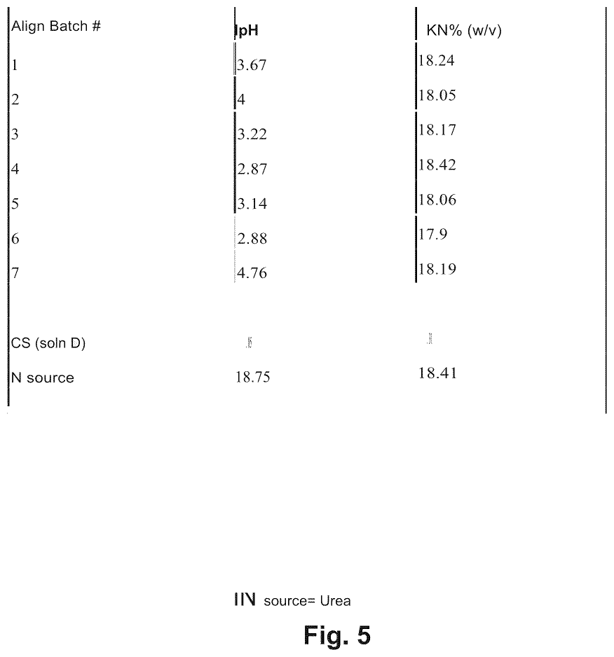

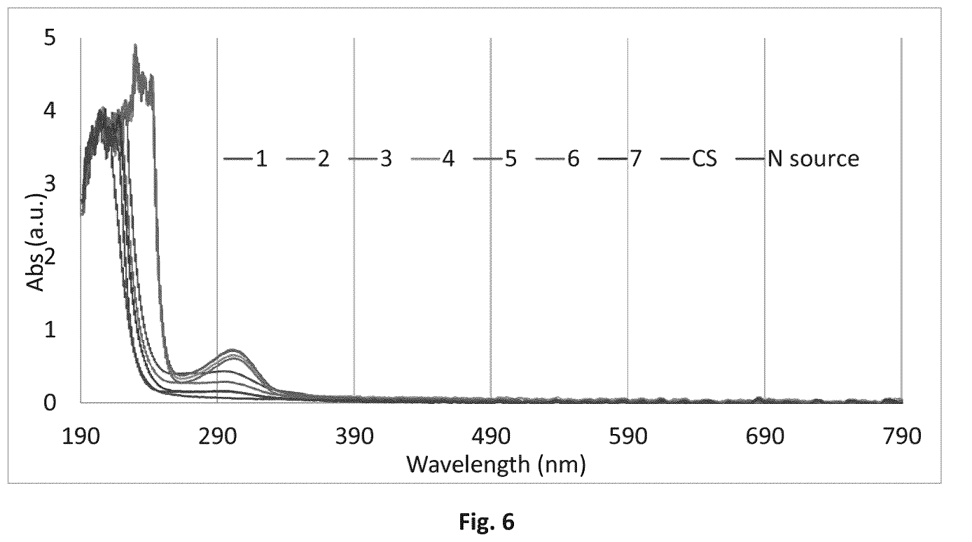

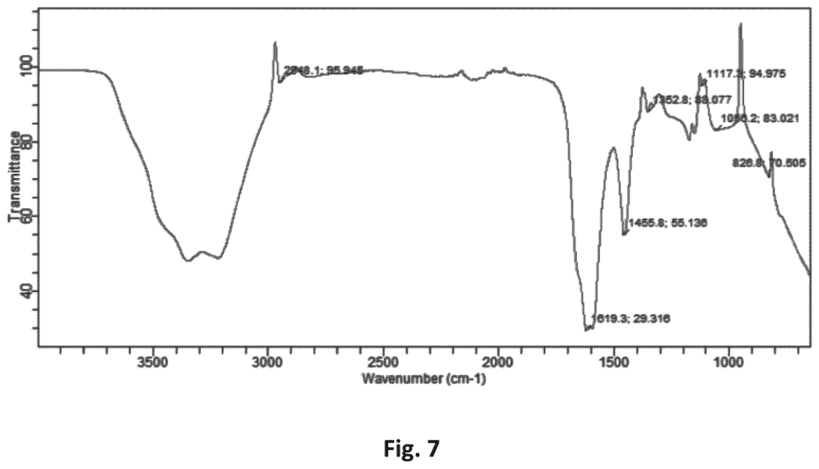

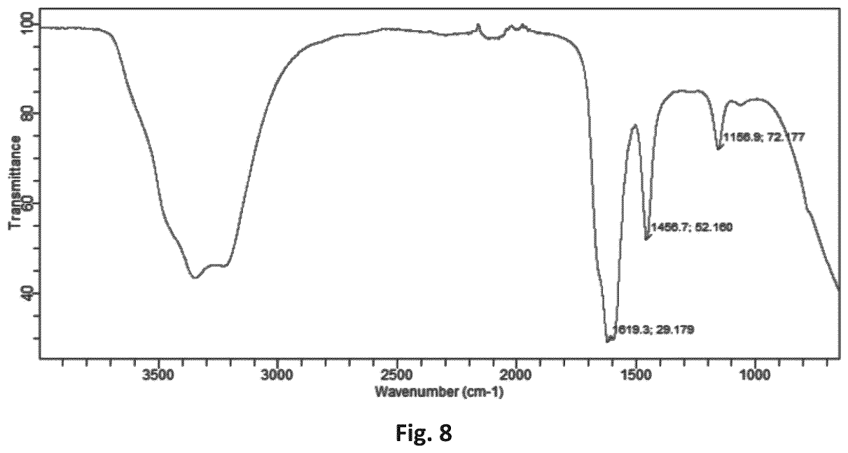

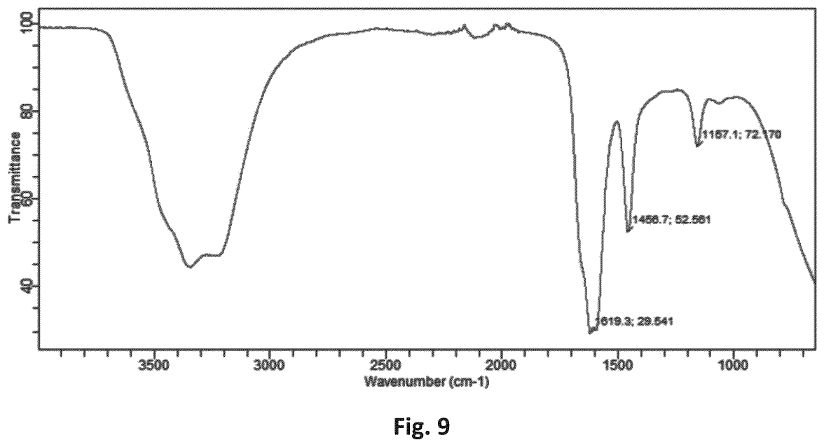

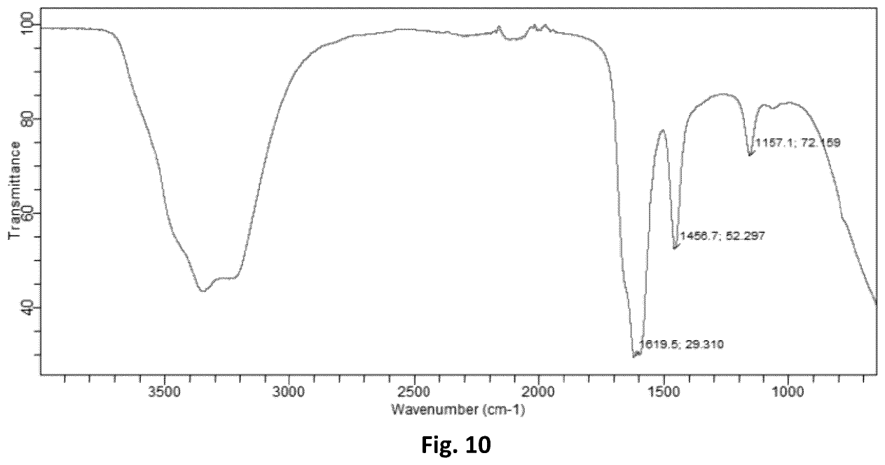

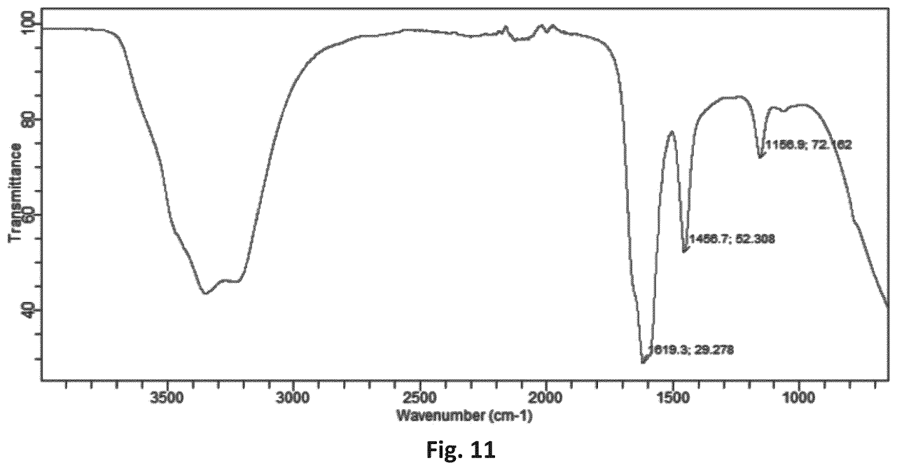

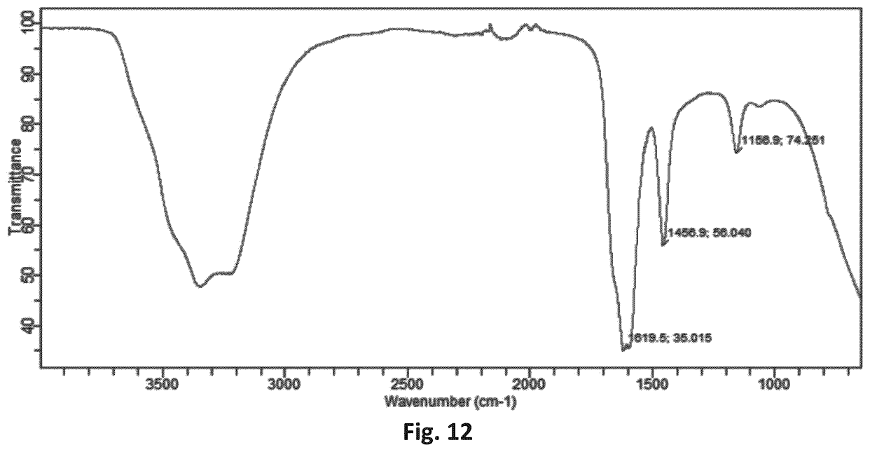

pH analysis (FIG. 5) was performed according to standard protocols for drinking water as described by the United States EPA. Total Kjeldahl Nitrogen (TKN) analysis (FIG. 5) was performed in accordance with method 1688 of the U. S. EPA Office of Water. The UV-Vis analysis (FIG. 6) was performed according to OPPTS 830.7050. The FTIR analysis (FIGS. 7-13) was performed on and according to the manual for the Agilent-Cary 630.

Multiple formulations utilizing the above-described methods were produced. Table 1 and Table 2 show the concentrations of each component of the composition or chitosan-based nanoparticle. Tables 1 and 2 also detail the physical characteristics of each chitosan-based nanoparticle, such as EC, density, viscosity, zeta potential, and particle size.

TABLE 1

| | | N % w/v * | | | Chitosan to | | | |
|---|---|---|---|---|---|---|---|---|
| Sr. | Exp. | (*sr 64-94 | N % | Chitosan | Nitrogen | Nitrogen | Coupling | Coupling |
| No. | Code | has w/w) | w/w | % w/v | ratio | source | Enhancer | Enhancer % |
| 1 | AN1101 | 20.01 | 18.191 | 1.29 | 0.064 | Urea | Ammonium | 0.01 |
| | | | | | | | Sulphate | |
| 2 | AN1101R1 | 20.01 | 18.191 | 1.27 | 0.063 | Urea | Ammonium | 0.01 |
| | | | | | | | Sulphate | |
| 3 | AN1117 | 20.01 | 18.191 | 1 | 0.050 | Urea | Ammonium | 0.01 |
| | | | | | | | Sulphate | |
| 4 | AN1119 | 20.01 | 18.191 | 1 | 0.050 | Urea | Ammonium | 0.01 |
| | | | | | | | Sulphate | |
| 5 | AN1102 | 20.01 | 18.191 | 0.8 | 0.040 | Urea | Ammonium | 0.01 |
| | | | | | | | Sulphate | |
| 6 | AN1103 | 20.01 | 18.191 | 0.8 | 0.040 | Urea | Ammonium | 0.01 |
| | | | | | | | Sulphate | |
| 7 | AN1105 | 20.01 | 18.191 | 0.8 | 0.040 | Urea | Trisodium | 0.01 |
| | | | | | | | Polyphosphate | |
| 8 | AN1118 | 20.01 | 18.191 | 0.8 | 0.040 | Urea | Ammonium | 0.01 |
| | | | | | | | Sulphate | |
| 9 | AN1114 | 20.01 | 18.191 | 0.45 | 0.022 | Urea | Ammonium | 0.01 |
| | | | | | | | Sulphate | |
| 10 | AN1104 | 20.01 | 18.191 | 0.4 | 0.020 | Urea | Ammonium | 0.01 |
| | | | | | | | Sulphate | |
| 11 | AN1106 | 20.01 | 18.191 | 0.4 | 0.020 | Urea | Trisodium | 0.01 |
| | | | | | | | Polyphosphate | |
| 12 | AN1107 | 20.01 | 18.191 | 0.4 | 0.020 | Urea | Ammonium | 0.01 |
| | | | | | | | Sulphate | |
| 13 | AN1108 | 20.01 | 18.191 | 0.4 | 0.020 | Urea | Trisodium | 0.01 |
| | | | | | | | Polyphosphate | |
| 14 | AN1104R1 | 20.01 | 18.191 | 0.4 | 0.020 | Urea | Ammonium | 0.01 |
| | | | | | | | Sulphate | |
| 15 | AN1104R2 | 20.01 | 18.191 | 0.4 | 0.020 | Urea | Trisodium | 0.01 |
| | | | | | | | Polyphosphate | |
| 16 | AN1115 | 20.01 | 18.191 | 0.4 | 0.020 | Urea | Ammonium | 0.01 |
| | | | | | | | Sulphate | |
| 17 | AN1111 | 20.01 | 18.358 | 0.3 | 0.015 | Urea | Ammonium | 0.01 |
| | | | | | | | Sulphate | |
| 18 | AN1111R1 | 20.01 | 18.191 | 0.3 | 0.015 | Urea | Ammonium | 0.01 |
| | | | | | | | Sulphate | |
| 19 | AN1112 | 20.01 | 18.191 | 0.3 | 0.015 | Urea | Ammonium | 0.01 |
| | | | | | | | Sulphate | |
| 20 | AN1113 | 20.01 | 18.191 | 0.3 | 0.015 | Urea | Ammonium | 0.01 |
| | | | | | | | Sulphate | |
| 21 | AN1113R1 | 20.01 | 18.191 | 0.3 | 0.015 | Urea | Ammonium | 0.01 |
| | | | | | | | Sulphate | |
| 22 | AN1109 | 20.01 | 18.358 | 0.2 | 0.010 | Urea | Ammonium | 0.01 |
| | | | | | | | Sulphate | |
| 23 | AN1110 | 20.01 | 18.358 | 0.2 | 0.010 | Urea | Ammonium | 0.01 |
| | | | | | | | Sulphate | |
| 24 | AN1120 | 20.01 | 18.027 | 0.2 | 0.010 | Urea | Ammonium | 0.01 |
| | | | | | | | Sulphate | |
| 25 | AN1121 | 19.87 | 16.558 | 0.2 | 0.010 | Urea + | Ammonium | 37.70 |
| | | | | | | Ammonium | Sulphate | |
| | | | | | | Sulphate | | |
| 26 | AN1132 | 19.87 | 16.154 | 0.2 | 0.010 | Urea + | Ammonium | 37.70 |
| | | | | | | Ammonium | Sulphate | |
| | | | | | | Sulphate | | |
| 27 | AN1131 | 20.01 | 18.191 | 0.2 | 0.010 | Urea | Ammonium | 0.01 |
| | | | | | | | Sulphate | |
| 28 | AN1113L1 | 20.01 | 18.191 | 0.3 | 0.015 | Urea | Ammonium | 0.01 |
| | | | | | | | Sulphate | |
| 29 | AN1113L2 | 20.01 | 18.191 | 0.3 | 0.015 | Urea | Ammonium | 0.01 |
| | | | | | | | Sulphate | |
| 30 | AN1113L3 | 20.01 | 18.191 | 0.3 | 0.015 | Urea | Ammonium | 0.01 |
| | | | | | | | Sulphate | |
| 31 | AN1113L4 | 20.01 | 18.358 | 0.3 | 0.015 | Urea | Ammonium | 0.01 |
| | | | | | | | Sulphate | |
| 32 | AN1113L5 | 20.01 | 18.358 | 0.3 | 0.015 | Urea | Ammonium | 0.01 |
| | | | | | | | Sulphate | |
| 33 | AN1120L5 | 20.01 | 18.027 | 0.2 | 0.010 | Urea | Ammonium | 0.01 |
| | | | | | | | Sulphate | |
| 34 | AN1121L5 | 19.87 | 16.287 | 0.2 | 0.010 | Urea + | Ammonium | 37.7 |
| | | | | | | Ammonium | Sulphate | |
| | | | | | | Sulphate | | |
| 35 | AN1122 | 20.01 | NA | 0.3 | 0.015 | Urea | Ammonium | 0.01 |
| | | | | | | | Sulphate | |
| 36 | AN1123 | 20.01 | NA | 0.3 | 0.015 | Urea | Ammonium | 3.01 |
| | | | | | | | Sulphate | |
| 37 | AN1127 | 20.01 | NA | 0.3 | 0.015 | Urea | Ammonium | 0.01 |
| | | | | | | | Sulphate | |
| 38 | AN1128 | 20.01 | NA | 0.3 | 0.015 | Urea | Ammonium | 0.01 |
| | | | | | | | Sulphate | |
| 39 | AN1129 | 20.01 | 18.19 | 0.3 | 0.015 | Urea | Ammonium | 0.01 |
| | | | | | | | Sulphate | |
| 40 | AN1130 | 20.01 | 18.19 | 0.3 | 0.015 | Urea | Ammonium | 0.01 |
| | | | | | | | Sulphate | |
| 41 | AN1124A | 20.01 | NA | 0.3 | 0.015 | Urea | NA | NA |
| 42 | AN1124B | 20.01 | NA | 0.3 | 0.015 | Urea | Ammonium | 0.01 |
| | | | | | | | Sulphate | |
| 43 | AN1124C | 20.03 | NA | 0.3 | 0.015 | Urea | Ammonium | 0.1 |
| | | | | | | | Sulphate | |
| 44 | AN1124D | 20.12 | NA | 0.3 | 0.015 | Urea | Ammonium | 0.5 |
| | | | | | | | Sulphate | |
| 45 | AN1124E | 20.22 | NA | 0.3 | 0.015 | Urea | Ammonium | 1 |
| | | | | | | | Sulphate | |
| 46 | AN1124F | 20.43 | NA | 0.3 | 0.015 | Urea | Ammonium | 2 |
| | | | | | | | Sulphate | |
| 47 | AN1124G | 20.65 | NA | 0.3 | 0.015 | Urea | Ammonium | 3 |
| | | | | | | | Sulphate | |
| 48 | AN1124H | 20.86 | NA | 0.3 | 0.014 | Urea | Ammonium | 4 |
| | | | | | | | Sulphate | |
| 49 | AN1124I | 21.07 | NA | 0.3 | 0.014 | Urea | Ammonium | 5 |
| | | | | | | | Sulphate | |
| 50 | AN1124J | 22.13 | NA | 0.3 | 0.014 | Urea | Ammonium | 10 |
| | | | | | | | Sulphate | |
| 51 | AN1124K | 24.26 | NA | 0.3 | 0.012 | Urea | Ammonium | 20 |
| | | | | | | | Sulphate | |
| 52 | AN1124L | 26.38 | NA | 0.3 | 0.011 | Urea | Ammonium | 30 |
| | | | | | | | Sulphate | |
| 53 | AN1125A | 20.01 | NA | 0.3 | 0.015 | Urea | NA | NA |
| 54 | AN1125B | 20.01 | NA | 0.3 | 0.015 | Urea | Trisodium | 0.001 |
| | | | | | | | Polyphosphate | |
| 55 | AN1125C | 20.01 | NA | 0.3 | 0.015 | Urea | Trisodium | 0.01 |
| | | | | | | | Polyphosphate | |
| 56 | AN1125D | 20.01 | NA | 0.3 | 0.015 | Urea | Trisodium | 0.1 |
| | | | | | | | Polyphosphate | |
| 57 | AN1125E | 20.01 | NA | 0.3 | 0.015 | Urea | Trisodium | 0.5 |
| | | | | | | | Polyphosphate | |
| 58 | AN1125F | 20.01 | NA | 0.3 | 0.015 | Urea | Trisodium | 1 |
| | | | | | | | Polyphosphate | |
| 59 | AN1126A | 5 | NA | 0.3 | 0.060 | Urea | Ammonium | 0.01 |
| | | | | | | | Sulphate | |
| 60 | AN1126B | 10 | NA | 0.3 | 0.030 | Urea | Ammonium | 0.01 |
| | | | | | | | Sulphate | |
| 61 | AN1126C | 15 | NA | 0.3 | 0.020 | Urea | Ammonium | 0.01 |
| | | | | | | | Sulphate | |
| 62 | AN1126D | 20.01 | NA | 0.3 | 0.015 | Urea | Ammonium | 0.01 |
| | | | | | | | Sulphate | |
| 63 | AN1133 | 20.01 | 18.191 | 0.3 | 0.015 | Urea | Ammonium | 0.01 |
| | | | | | | | Sulphate | |
| 64 | E23291 | 20 | 20 | 0.3 | 0.015 | Urea | Ammonium | 0.01 |
| | | | | | | | Sulphate | |
| 65 | E23293 | 15.65 | 15.65 | 0.3 | 0.019 | Urea + | Ammonium | 19.05 |
| | | | | | | Ammonium | Sulphate | |
| | | | | | | Sulphate | | |
| 66 | E23294 | 20 | 20 | 0.8 | 0.040 | Urea | Ammonium | 0.01 |
| | | | | | | | Sulphate | |
| 67 | E23297 | 6.66 | 6.66 | 0.8 | 0.120 | Urea | Ammonium | 0.01 |
| | | | | | | | Sulphate | |
| 68 | EZ1241121 | 20 | 20 | 0.3 | 0.015 | Urea | Ammonium | 0.01 |
| | | | | | | | Sulphate | |
| 69 | EZ1241122 | 20 | 20 | 1.6 | 0.080 | Urea | Ammonium | 0.01 |
| | | | | | | | Sulphate | |
| 70 | EZ1241123 | 15.65 | 15.65 | 0.3 | 0.019 | Urea + | Ammonium | 19.05 |
| | | | | | | Ammonium | Sulphate | |
| | | | | | | Sulphate | | |
| 71 | EZ1241124 | 13.94 | 13.94 | 1.6 | 0.115 | Urea + | Ammonium | 16.87 |
| | | | | | | Ammonium | Sulphate | |
| | | | | | | Sulphate | | |
| 72 | EZ1241125 | 8.29 | 8.29 | 0.3 | 0.036 | Ammonium | Ammonium | 39.48 |
| | | | | | | Sulphate | Sulphate | |
| 73 | EZ1241187 | 2.19 | 2.19 | 9 | 4.110 | Urea | Ammonium | 0.01 |
| | | | | | | | Sulphate | |
| 74 | EZ1241188 | 5 | 5 | 7.8 | 1.560 | Urea | Ammonium | 0.01 |
| | | | | | | | Sulphate | |
| 75 | EZ1241189 | 10 | 10 | 5.76 | 0.576 | Urea | Ammonium | 0.01 |
| | | | | | | | Sulphate | |
| 76 | EZ12411810 | 15 | 15 | 3.68 | 0.245 | Urea | Ammonium | 0.01 |
| | | | | | | | Sulphate | |
| 77 | EZ224261 | 20 | 20 | 0.3 | 0.015 | Urea | Ammonium | 0.01 |
| | | | | | | | Sulphate | |
| 78 | EZ224252 | 20 | 20 | 1.6 | 0.080 | Urea | Ammonium | 0.01 |
| | | | | | | | Sulphate | |
| 79 | EZ2241293 | 15.65 | 15.65 | 0.3 | 0.019 | Urea + | Ammonium | 19.05 |
| | | | | | | Ammonium | Sulphate | |
| | | | | | | Sulphate | | |
| 80 | EZ224274 | 13.94 | 13.94 | 1.6 | 0.115 | Urea + | Ammonium | 16.87 |
| | | | | | | Ammonium | Sulphate | |
| | | | | | | Sulphate | | |
| 81 | EZ2241245 | 8.29 | 8.29 | 0.3 | 0.036 | Ammonium | Ammonium | 39.48 |
| | | | | | | Sulphate | Sulphate | |
| 82 | EZ224286 | 2.19 | 2.19 | 9 | 4.110 | Urea | Ammonium | 0.01 |
| | | | | | | | Sulphate | |
| 83 | EZ224217 | 5 | 5 | 7.8 | 1.560 | Urea | Ammonium | 0.01 |
| | | | | | | | Sulphate | |
| 84 | EZ2241308 | 10 | 10 | 5.76 | 0.576 | Urea | Ammonium | 0.01 |
| | | | | | | | Sulphate | |
| 85 | EZ2241319 | 15 | 15 | 3.68 | 0.245 | Urea | Ammonium | 0.01 |
| | | | | | | | Sulphate | |
| 86 | EUL242161 | 20 | 20 | 0.3 | 0.015 | Urea | Ammonium | 0.01 |
| | | | | | | | Sulphate | |
| 87 | EUL242192 | 20 | 20 | 1.6 | 0.080 | Urea | Ammonium | 0.01 |
| | | | | | | | Sulphate | |
| 88 | EUL242273 | 15.65 | 15.65 | 0.3 | 0.019 | Urea + | Ammonium | 19.05 |
| | | | | | | Ammonium | Sulphate | |
| | | | | | | Sulphate | | |
| 89 | EUL242284 | 13.94 | 13.94 | 1.6 | 0.115 | Urea + | Ammonium | 16.87 |
| | | | | | | Ammonium | Sulphate | |
| | | | | | | Sulphate | | |
| 90 | EUL242285 | 8.29 | 8.29 | 0.3 | 0.036 | Ammonium | Ammonium | 39.48 |
| | | | | | | Sulphate | Sulphate | |
| 91 | EUL24316 | 2.19 | 2.19 | 9 | 4.110 | Urea | Ammonium | 0.01 |
| | | | | | | | Sulphate | |
| 92 | EUL24317 | 5 | 5 | 7.8 | 1.560 | Urea | Ammonium | 0.01 |
| | | | | | | | Sulphate | |
| 93 | EUL24318 | 10 | 10 | 5.76 | 0.576 | Urea | Ammonium | 0.01 |
| | | | | | | | Sulphate | |
| 94 | EUL242299 | 15 | 15 | 3.68 | 0.245 | Urea | Ammonium | 0.01 |
| | | | | | | | Sulphate | |

TABLE 2

| | | | | | | | | | | Particle |
|---|---|---|---|---|---|---|---|---|---|---|
| | | Glacial | | | | | | | Zeta | Size |
| Sr. | Exp. | acetic | | Nitric | | EC | Density | Viscosity | Potential | by DLS |
| No. | Code | acid % | HCl % | acid % | pH | (mS/cm) | (g/cm) | (cp) | (mV) | (number) |
| 1 | AN1101 | 0.7 | 0.7 | 0 | 3.67 | NA | 1.10 | NA | NA | NA |
| 2 | AN1101R1 | 0.63 | 0.63 | 0 | 3.61 | NA | 1.10 | NA | NA | NA |
| 3 | AN1117 | 0.8 | 0 | 0 | 4.6 | NA | 1.10 | NA | NA | NA |
| 4 | AN1119 | 0.8 | 0.8 | 0 | 2.51 | NA | 1.10 | NA | NA | NA |
| 5 | AN1102 | 0.4 | 0.4 | 0 | 4 | NA | 1.10 | NA | NA | NA |
| 6 | AN1103 | 0.4 | 0 | 0.4 | 3.22 | NA | 1.10 | NA | NA | NA |
| 7 | AN1105 | 0.4 | 0 | 0.4 | 3.14 | NA | 1.10 | NA | NA | NA |
| 8 | AN1118 | 0 | 0.8 | 0 | 2.57 | NA | 1.10 | NA | NA | NA |
| 9 | AN1114 | 0.15 | 0.25 | 0.15 | 3.48 | NA | 1.10 | NA | NA | NA |
| 10 | AN1104 | 0 | 0 | 0.4 | 2.87 | NA | 1.10 | NA | NA | NA |
| 11 | AN1106 | 0 | 0 | 0.4 | 2.88 | NA | 1.10 | NA | NA | NA |
| 12 | AN1107 | 0.4 | 0 | 0 | 4.76 | NA | 1.10 | NA | NA | NA |
| 13 | AN1108 | 0.4 | 0 | 0 | 4.74 | NA | 1.10 | NA | NA | NA |
| 14 | AN1104R1 | 0 | 0 | 0.4 | 2.86 | NA | 1.10 | NA | NA | NA |
| 15 | AN1104R2 | 0 | 0 | 0.4 | 2.86 | NA | 1.10 | NA | NA | NA |
| 16 | AN1115 | 0 | 0.5 | 0 | 2.86 | NA | 1.10 | NA | NA | NA |
| 17 | AN1111 | 0.15 | 0.15 | 0 | 4.4 | NA | 1.09 | NA | NA | NA |
| 18 | AN1111R1 | 0.15 | 0.15 | 0 | 4.42 | NA | 1.10 | NA | NA | NA |
| 19 | AN1112 | 0.15 | 0.15 | 0 | 4.35 | NA | 1.10 | NA | NA | NA |
| 20 | AN1113 | 0.15 | 0.25 | 0 | 3.59 | NA | 1.10 | NA | NA | NA |
| 21 | AN1113R1 | 0.15 | 0.25 | 0 | 3.45 | NA | 1.10 | NA | NA | NA |
| 22 | AN1109 | 0.200 | 0.000 | 0.000 | 4.920 | NA | 1.090 | NA | NA | NA |
| 23 | AN1110 | 0.200 | 0.000 | 0.000 | 6.330 | NA | 1.090 | NA | NA | NA |
| 24 | AN1120 | 0.400 | 0.800 | 0.000 | 2.370 | NA | 1.110 | NA | NA | NA |
| 25 | AN1121 | 0.000 | 0.200 | 0.000 | 3.800 | NA | 1.200 | NA | NA | NA |
| 26 | AN1132 | 0.000 | 0.200 | 0.000 | 3.790 | 156.310 | 1.230 | 5.220 | 9.300 | 321.300 |
| 27 | AN1131 | 0.4 | 0.8 | 0 | 2.4 | 7.54 | 1.10 | 3.19 | NA | NA |
| 28 | AN1113L1 | 0.15 | 0.25 | 0 | 3.51 | NA | 1.10 | NA | NA | NA |
| 29 | AN1113L2 | 0.15 | 0.25 | 0 | 3.5 | NA | 1.10 | NA | NA | NA |
| 30 | AN1113L3 | 0.15 | 0.24 | 0 | 3.43 | 1.82 | 1.10 | NA | NA | NA |
| 31 | AN1113L4 | 0.15 | 0.24 | 0 | 3.51 | 1.84 | 1.09 | NA | NA | NA |
| 32 | AN1113L5 | 0.15 | 0.24 | 0 | 3.5 | 1.83 | 1.09 | NA | 53.95 | 50.7 |
| 33 | AN1120L5 | 0.4 | 0.8 | 0 | 2.31 | 7.59 | 1.11 | NA | 29.59 | 93.26 |
| 34 | AN1121L5 | 0 | 0.2 | 0 | 3.77 | 155.16 | 1.22 | NA | 9.96 | 518.6 |
| 35 | AN1122 | 0.15 | 0.15 | 0 | 2.81 | 3.46 | NA | NA | NA | NA |
| 36 | AN1123 | 0.15 | 0.15 | 0 | 4.52 | 27.55 | NA | NA | NA | NA |
| 37 | AN1127 | 0.23 | 0.15 | 0 | 5.13 | NA | NA | NA | 15.77 | 68.54 |
| 38 | AN1128 | 0.15 | 0.15 | 0 | 4.54 | NA | NA | NA | NA | NA |
| 39 | AN1129 | 0.15 | 0.24 | 0 | 3.36 | 1.84 | 1.10 | 5.43 | 57.7 | 40.82 |
| 40 | AN1130 | 0.38 | 0.24 | 0 | 4.39 | 1.59 | 1.10 | 5.43 | NA | NA |
| 41 | AN1124A | 0.15 | 0.15 | 0 | 4.51 | 1.34 | NA | NA | NA | NA |
| 42 | AN1124B | 0.15 | 0.15 | 0 | 4.34 | 1.33 | NA | NA | NA | NA |
| 43 | AN1124C | 0.15 | 0.15 | 0 | 4.42 | 2.2 | NA | NA | NA | NA |
| 44 | AN1124D | 0.15 | 0.15 | 0 | 4.44 | 6.36 | NA | NA | NA | NA |
| 45 | AN1124E | 0.15 | 0.15 | 0 | 4.45 | 11.03 | NA | NA | NA | NA |
| 46 | AN1124F | 0.15 | 0.15 | 0 | 4.44 | 19.4 | NA | NA | NA | NA |
| 47 | AN1124G | 0.15 | 0.15 | 0 | 4.43 | 27.4 | NA | NA | NA | NA |
| 48 | AN1124H | 0.15 | 0.15 | 0 | 4.45 | 33.96 | NA | NA | NA | NA |
| 49 | AN1124I | 0.15 | 0.15 | 0 | 4.46 | 39.99 | NA | NA | NA | NA |
| 50 | AN1124J | 0.15 | 0.15 | 0 | 4.35 | 65.02 | NA | NA | NA | NA |
| 51 | AN1124K | 0.15 | 0.15 | 0 | 4.41 | 92.64 | NA | NA | 11.71 | 80.79 |
| 52 | AN1124L | 0.15 | 0.15 | 0 | 4.45 | 102.52 | NA | NA | 5.14 | 49.46 |
| 53 | AN1125A | 0.15 | 0.15 | 0 | 4.62 | 1.43 | NA | NA | NA | NA |
| 54 | AN1125B | 0.15 | 0.15 | 0 | 4.34 | 1.27 | NA | NA | NA | NA |
| 55 | AN1125C | 0.15 | 0.15 | 0 | 4.32 | 1.35 | NA | NA | NA | NA |
| 56 | AN1125D | 0.15 | 0.15 | 0 | 4.71 | 1.67 | NA | NA | NA | NA |
| 57 | AN1125E | 0.15 | 0.15 | 0 | 5.84 | 4.13 | NA | NA | NA | NA |
| 58 | AN1125F | 0.15 | 0.15 | 0 | 6.96 | 6.96 | NA | NA | NA | NA |
| 59 | AN1126A | 0.15 | 0.15 | 0 | 3.53 | 1.59 | NA | NA | 30.37 | 48.04 |
| 60 | AN1126B | 0.15 | 0.15 | 0 | 3.81 | 1.55 | NA | NA | NA | NA |
| 61 | AN1126C | 0.15 | 0.15 | 0 | 4.11 | 1.48 | NA | NA | NA | NA |
| 62 | AN1126D | 0.15 | 0.15 | 0 | 4.47 | 1.4 | NA | NA | NA | NA |
| 63 | AN1133 | 0.15 | 0.32 | 0 | 3.48 | 2.52 | 1.10 | 6.94 | NA | NA |
| 64 | E23291 | 0.15 | 0.15 | 0 | 3.55 | 1.9 | 1.11 | 8.052 | 55.2 | 91.07 |
| 65 | E23293 | 0.15 | 0.15 | 0 | 4.01 | 128.76 | 1.18 | 6.431 | 10.92 | 258.9 |
| 66 | E23294 | 0.4 | 0.4 | 0 | 3.65 | 2.97 | 1.12 | 29.45 | 57.01 | 114.5 |
| 67 | E23297 | 0.4 | 0.4 | 0 | 3.49 | 3.27 | 1 | 18.54 | 63.14 | 153.8 |
| 68 | EZ1241121 | NA | NA | NA | 4.53 | 1.08 | 1.11 | 1.967 | 50.6 | 165.6 |
| 69 | EZ1241122 | NA | NA | NA | 5 | 2.74 | 1.12 | 3.766 | 47.08 | 227.5 |
| 70 | EZ1241123 | NA | NA | NA | 4.65 | 128.69 | 1.17 | 2.321 | 3.92 | 173.1 |
| 71 | EZ1241124 | NA | NA | NA | 4.82 | 119.62 | 1.16 | 3.646 | 9.07 | 323.1 |
| 72 | EZ1241125 | NA | NA | NA | 4.67 | 263 | 1.22 | 2.597 | 8.23 | 175.8 |
| 73 | EZ1241187 | NA | NA | NA | 4.33 | 11.19 | 1.051 | 21.5 | 49.3 | 278.1 |
| 74 | EZ1241188 | NA | NA | NA | 4.47 | 10.44 | 1.063 | 16.95 | 47.14 | 228.2 |
| 75 | EZ1241189 | NA | NA | NA | 4.57 | 7.89 | 1.075 | 8.998 | 45.92 | 217.2 |
| 76 | EZ12411810 | NA | NA | NA | 4.81 | 5.83 | 1.10 | 7.198 | 46.3 | 345.6 |
| 77 | EZ224261 | NA | NA | NA | 4.84 | 1.83 | 1.11 | 1.889 | 46.98 | 124 |
| 78 | EZ224252 | NA | NA | NA | 4.97 | 3.42 | 1.11 | 3.96 | 48.28 | 142.6 |
| 79 | EZ2241293 | NA | NA | NA | 4.69 | 133.04 | 1.17 | 2.537 | 8.03 | 396 |
| 80 | EZ224274 | NA | NA | NA | 4.75 | 121.71 | 1.15 | 3.71 | 10.27 | 626.2 |
| 81 | EZ2241245 | NA | NA | NA | 4.63 | 267.42 | 1.22 | 2.735 | 9.97 | 194.3 |
| 82 | EZ224286 | NA | NA | NA | 4.3 | 10.62 | 1.04 | 21.15 | 43.29 | 205.7 |
| 83 | EZ224217 | NA | NA | NA | 4.37 | 9.8 | 1.06 | 19.62 | 38.61 | 180.1 |
| 84 | EZ2241308 | NA | NA | NA | 4.59 | 7.98 | 1.08 | 12.9 | 40.46 | 231.7 |
| 85 | EZ2241319 | NA | NA | NA | 4.76 | 5.7 | 1.09 | 7.99 | 41.38 | 240.5 |
| 86 | EUL242161 | NA | NA | NA | 5.02 | 1.68 | 1.11 | 1.54 | 36.66 | 140.5 |
| 87 | EUL242192 | NA | NA | NA | 5.53 | 3.86 | 1.12 | 2.3 | 37.7 | 131.4 |
| 88 | EUL242273 | NA | NA | NA | 5.08 | 134.37 | 1.17 | 2.24 | 2.46 | 157.4 |
| 89 | EUL242284 | NA | NA | NA | 5.41 | 120.77 | 1.16 | 2.5 | 5.38 | 106.8 |
| 90 | EUL242285 | NA | NA | NA | 5.29 | 259.38 | 1.22 | 2.32 | 2.54 | 170.4 |
| 91 | EUL24316 | NA | NA | NA | 5.04 | 12.33 | 1.06 | 4.72 | 34.66 | 74.56 |
| 92 | EUL24317 | NA | NA | NA | 5.11 | 11.18 | 1.07 | 4.19 | 34.17 | 233.2 |
| 93 | EUL24318 | NA | NA | NA | 5.26 | 9.04 | 1.09 | 3.37 | 34.2 | 176.9 |
| 94 | EUL242299 | NA | NA | NA | 5.44 | 6.52 | 1.15 | 2.59 | 32.6 | 153.7 |

### Example 4: Application and Uses of the Chitosan and/or Chitosan/Nitrogen Nanoparticles

The resultant chitosan and/or chitosan-based nanoparticle products or mixtures of products obtained as a result of the above Examples were used for the multidimensional effects on plants such as growth, protection, and nutrition. The multidimensional effects on plants were obtained by applying the resultant product of the above Examples onto the fertilizer granule, seed surface, mixing in the soil, inserting into the soil, exposing root, and/or exposing leaves. The application rate ranged between 0.01% to 50% v/w or v/v. Furthermore, the resultant products of the above Examples were used to mix with other agrochemicals to function as growth promoter, symbiont, nutrient, protection agent against pathogens or non-desired plants for synergistic effects.

The multidimensional effects on plants were studied in several experiments. The experiments used either a 2% or 3% chitosan formulation.

A 2% chitosan formulation AN1136 (Tables 1 and 2) was produced according to the following procedure.

Begin by pouring 200 ml of water into a 500 mL capacity beaker, ensuring precise measurement. Switch on the magnetic stirrer set at room temperature (26.4° C.) and programmed to operate at 300 rotations per minute (RPM). Maintain the continuous stirring throughout the procedure until instructed otherwise. Allow the water to stir for 5 minutes to establish a uniform environment within the beaker. After this duration, carefully introduce 5 grams of chitosan flakes into the stirring water. Following the addition of chitosan flakes, continue stirring for an additional 15 minutes to facilitate their dispersion and interaction with the water molecules. At this point, add 5 mL of 37% hydrochloric acid (HCl) to the solution. Observe the solution closely, allowing sufficient time (approximately 60 minutes) for the chitosan flakes to fully dissolve into the liquid medium, ensuring thorough mixing and dissolution. Once complete dissolution is achieved, introduce an additional 40 mL of water into the solution, maintaining the stirring process to ensure homogeneity. Continue stirring the solution with the newly added water for an additional 15 minutes to ensure proper mixing and equilibration. Following the stirring period, deactivate the magnetic stirrer. To compensate for any volume loss during the process, adjust the solution's volume to 250 mL by adding 5 mL of water. Ensure thorough mixing to achieve a uniform solution. To remove any remaining particulate matter or impurities, filter the solution using a 200 mesh (74 micron) size filter, allowing only the liquid portion to pass through while retaining any solid residues.

TABLE 3

| Sr. No. | Parameter | Results |
|---|---|---|
| 1 | pH | 0.72 |
| 2 | Conductivity (mS/cm) | 51.74 |
| 3 | Density (g/cm3) | 1.0 |
| 4 | Viscosity (cps) | 71.09 |
| 5 | Chitosan % | 2 |
| 6 | HCL % (v/v) | 2 |

A Nitrogen Precursor Solution is prepared. Begin by selecting a 2000 mL beaker, ensuring it is clean and dry, ready for use in the experiment. Carefully measure out 490 mL of water, using a graduated cylinder, and pour it into the chosen beaker. Transfer the prepared beaker containing the measured water to an overhead stirrer apparatus. Ensure the apparatus is set up properly and calibrated and set the stirring speed to 300 rotations per minute (RPM). Additionally, ensure that the room temperature is maintained at 25° C., providing an optimal environment for the experiment. After allowing the water to stir for 5 minutes, gradually introduce 260 grams of the nitrogen source, which in this case is urea. Add the urea slowly to the stirring water, ensuring even distribution and dissolution within the solution. Once the urea has been added, allow the solution to continue stirring for an extended period of 120 minutes, providing ample time for the urea to fully dissolve and integrate into the water. Following the dissolution of the urea, add 377 grams of ammonium sulfate to the solution. Similar to the urea addition, introduce the ammonium sulfate gradually, allowing it to dissolve and disperse evenly within the solution. After allowing the solution to stir for an additional 120 minutes following the addition of ammonium sulfate, carefully observe the solution to determine if the ammonium sulfate has dissolved completely. Ensure thorough mixing and dissolution by visually inspecting the solution for any remaining solid particles. Once dissolution is confirmed, stop the overhead stirrer apparatus, bringing the stirring process to a halt. Ensure that the stirrer is switched off completely to prevent any unnecessary agitation of the solution. To verify the final volume of the solution, measure it using a graduated cylinder or volumetric flask. The volume should ideally measure around 900 ml, indicating successful completion of the experiment and accurate preparation of the solution.

TABLE 4

| Sr. | | |
|---|---|---|
| No. | Parameter | Results |
| 1 | pH | 5.64 |
| 2 | Conductivity (mS/cm) | 143.90 |
| 3 | Density (g/cm3) | 1.25 |
| 4 | Viscosity (cps) | 3.88 |

Once the precursor chitosan and nitrogen solutions are prepared. The chitosan-based nanoparticle solution is prepared.

Select a clean and dry 2000 mL beaker to serve as the vessel for the experiment. Using a precise measuring instrument such as a 1000 mL measuring cylinder, carefully measure out 900 mL of the nitrogen precursor solution. Pour this measured volume of the solution into the prepared beaker, ensuring accuracy in measurement to achieve consistent results. Once the nitrogen precursor solution is added to the beaker, transfer the beaker to an overhead stirrer apparatus. Ensure the apparatus is properly set up and calibrated and set the stirring speed to 300 rotations per minute (RPM). Maintain the ambient room temperature to provide an optimal environment for the experiment. After allowing the solution to stir for a duration of 30 minutes, proceed to add 100 mL of a 2% chitosan solution to the stirring nitrogen precursor solution. Slowly introduce the chitosan solution to the stirring solution, ensuring thorough mixing and uniform distribution within the beaker. Following the addition of the chitosan solution, allow the solution to continue stirring for an extended period of 3 hours, providing ample time for any reactions or interactions to occur between the components of the solution. After this duration, stop the overhead stirrer to bring the stirring process to a halt. To determine the final volume of the solution, measure it using a suitable measuring instrument, ensuring measurement accuracy. Ideally, the measured volume should be around 1000 mL, indicating successful completion of the experiment and proper preparation of the solution. Proceed to filter the solution using a 200-mesh filtration unit. This filtration process should take approximately 18 seconds to complete, effectively removing any larger particles or impurities present in the solution. Following the initial filtration, repeat the filtration process using a 5-micron filtration unit. This secondary filtration step further refines the solution, removing smaller particles and ensuring a higher level of purity. The filtration process with the 5-micron unit should take approximately 20 seconds to complete. Once the solution is filtered, transfer it to a suitable storage container, such as a high-density polyethylene (HDPE) bottle, ensuring that it is tightly sealed to prevent contamination. Store the filtered solution at 20 deg C. temperature until further use.

TABLE 5

| Sr. | | |
|---|---|---|
| No. | Parameter | Results |
| 1 | Chitosan % (w/v) | 0.2 |
| 2 | HCL % (v/v) | 0.2 |
| 3 | Urea % (w/v) | 26 |
| 4 | N in urea % (w/v) | 11.96 |
| 5 | Ammonium Sulfate % (w/v) | 37.7 |
| 6 | N in Ammonium Sulfate % (w/v) | 7.91 |
| 7 | Sulfur in Ammonium Sulfate % (w/v) | 9.1 |
| 8 | Sulfate in Ammonium Sulfate % (w/v) | 27.4 |
| 9 | Total Nitrogen % (w/v) | 19.87 |

TABLE 6

| Test Parameter | Unit | Value | Std Dev. |
|---|---|---|---|
| pH | | 3.81 | |
| EC | mS/cm | 159.37 | |
| Viscosity | cps | 5.35 | |
| Density | g/cm3 | 1.23 | |
| Nitrogen (TKN) | % | 19.87 | |
| Sulfur | % | 9.1 | |
| Chitosan | % | 0.2 | |
| Hydrodynamic Size (by number) | nm | 422.2 | 16.57 |
| Hydrodynamic Size (by Intensity) | nm | 491.5 | 25.13 |
| Hydrodynamic Size (by Z Average) | nm | 454.8 | 10.3 |
| Zeta Potential by DLS | mV | 9.857 | 0.4218 |

A 3% chitosan formulation EZ2241293 (Tables 1 and 2) was produced according to the following procedure.

The formulation begins with the Preparation of an Intermediate solution. This begins with Preparation of N Source Stock Solution (w/w). First, prepare a 2000 ml capacity glass beaker by placing it carefully on the weighing machine to ensure accurate measurement. Take note of its initial weight. With precision, pour 400 grams of water into the beaker, ensuring that the measurement is exact. Once the water is added, activate the overhead stirrer, setting it to a constant rotation speed of 300 RPM. Ensure the temperature of the solution remains stable at 25° C. throughout this process. Gradually add 435 grams of Urea to the stirring solution, taking care to maintain a consistent mixing rate. Allow the solution to blend thoroughly for a duration of 3 hours, maintaining the stirring speed at 300 RPM and the temperature at 25° C. This ensures the complete integration of the Urea into the solution. Upon completion of the stirring process, carefully halt the operation of the overhead stirrer. To determine the final weight of the solution. Measure the weight of the beaker containing the solution, noting any changes from its initial weight. The final weight should be recorded, indicating the successful incorporation of the Urea into the solution, resulting in a total weight of 833 grams. To refine the solution, proceed to filter it through a mesh with a 200-mesh size. This step ensures the removal of any impurities or undissolved particles. The composition (w/w) of this intermediate solution is Urea: 52.09%, and Nitrogen: 23.96%. Table 3 details the characteristics of the solution.

TABLE 7

| Sr. No. | Parameter | Results |
|---|---|---|
| 1 | pH (Before adjusting) | 8.29 |
| 2 | Conductivity (mS/cm) Before | 0.10 |
| | adjusting) | |
| 3 | Conductivity (mS/cm) (After | 1.18 |
| | adjusting) | |
| 4 | Density (g/cm³) | 1.13 |
| 5 | Viscosity (cps) | 1.96 |

Second is the Preparation of an Ammonium Sulphate Stock Solution (w/w). Begin by selecting a dry and pristine 1000 ml beaker, ensuring it is free from any residues or contaminants. Place the beaker meticulously onto the weighing machine to prepare for precise measurements. Carefully pour 290 grams of water into the clean beaker, exercising precision to achieve an accurate measurement. With the water added, initiate the overhead stirrer, configuring it to rotate at a consistent speed of 300 RPM. Maintain a stable temperature of 25° C. throughout this process to ensure optimal conditions for mixing. Introduce 210 grams of Ammonium Sulphate into the stirring solution, methodically incorporating it to ensure thorough dispersion. Allow the solution to blend harmoniously for 3 hours, maintaining the stirring speed at 300 RPM and the temperature at 25° C. Upon completion of the stirring cycle, carefully disengage the overhead stirrer, bringing the mixing process to a controlled halt. Utilize the weighing machine to measure the weight of the beaker containing the solution, noting any deviations from its initial weight. The recorded final weight should reflect the successful incorporation of the Ammonium Sulphate, resulting in a total weight of 498.09 grams. To refine the solution further, proceed with the filtration process using a mesh with a 200-mesh size. This step serves to eliminate any impurities or undissolved particles. The Composition (w/w) of the ammonium stock solution is Ammonium sulphate: 42%, Sulphur: 10.18%, Nitrogen: 8.90% Sulphate: 30.5%.

TABLE 8

| Sr. No. | Parameter | Results |
|---|---|---|
| 1 | pH | 4.91 |
| 2 | Conductivity (mS/cm) | 266.73 |
| 3 | Density (g/cm³) | 1.23 |
| 4 | Viscosity (cps) | 2.74 |

The preparation of the chitosan-based nanoparticle EZ2244810 uses the stock solutions prepared above and proceeds as follows. Begin by meticulously weighing the 1000 mL capacity glass beaker. Add 486.32 grams of N source from Urea into the beaker. To adjust the pH to the desired level of 3.57, carefully introduce approximately 0.7 mL of Hydrochloric Acid (HCl), ensuring thorough mixing to achieve uniformity in pH distribution. Similarly, prepare another 1000 mL capacity glass beaker by taring the weighing machine, ensuring accurate measurements for subsequent steps. In this prepared beaker, add 453.48 grams of N source from Ammonium Sulphate, maintaining precision throughout the process. Utilize a separate weighing paper, taring the weighing machine to ensure accurate measurement, preparing for the addition of 0.1 gram of potassium sorbate, ensuring precise measurement for each component. Prepare a separate 20 mL capacity glass beaker by taring the weighing machine and adding 7.5 grams of water, maintaining accuracy in measurement. Weigh the 2000 mL capacity glass beaker, taring the weighing machine, and add 30 grams of Zale-2 solution from the stock. Position the beaker under the overhead stirrer, setting it to rotate at 300 RPM and maintaining a constant temperature of 25° C. After 15 minutes of stirring, introduce 486.32 grams of N source from Urea into the solution, ensuring even distribution through gentle mixing. Thirty minutes later, add 453.48 grams of N source from Ammonium Sulphate to the solution, maintaining the stirring process for uniform incorporation. Subsequently, introduce 0.1 gram of solid potassium sorbate into the solution after another 30 minutes, ensuring thorough mixing for homogeneity. After an additional 5 minutes, add 30 grams of water to the solution, maintaining the stirring process to ensure complete integration. Continue stirring the solution for a total duration of 3 hours, allowing ample time for all components to fully dissolve and interact. Upon completion of the stirring cycle, carefully halt the stirrer, bringing the mixing process to a controlled stop. Measure the final weight of the solution, which should amount to 991 grams, with an additional 8.42 grams accounted for as solution transfer loss. Proceed to filter the solution using a 200 mesh filtration unit, with a filtration time of approximately 10 seconds, ensuring the removal of any impurities or undissolved particles. Further refine the solution by filtering it through a 5-micron filtration unit, with a filtration time of approximately 13 seconds, enhancing the purity and clarity of the solution. After filtration, reweigh the solution to determine its final weight, which should now be approximately 982.5 grams, with an additional 9 grams accounted for as solution loss during filtration. Store the purified solution in a 1000 mL HDPE bottle, ensuring proper sealing to maintain its integrity until further use.

TABLE 9

| Sr. No. | Parameter | Results |
|---|---|---|
| 1 | Color | Amber |
| 2 | pH | 4.51 |
| 3 | Conductivity (mS/cm) | 131.14 |
| 4 | Density (g/cm³) | 1.17 |
| 5 | Viscosity (cps) | 2.52 |

The final composition (w/w) of the chitosan-based nanoparticle EZ2241293 is Chitosan=0.3%, Total Nitrogen (w/v)=15.64%, Total Ammonium Sulphate (with linker)=19.06%, N in Urea=11.65%, N in AS=3.99%, S in AS=4.62%, Sulfate=13.84, Potassium sorbate: 0.01%, and Con. HCL (use as pH maintain of urea sol.): 700 microliters.

A first experiment was performed in a hydroponic environment. Lettuce was grown in a hydroponic system to evaluate the effect of a chitosan-based nanoparticle, EZ2241293 (see Tables 1 and 2), on lettuce.

The experiment included five tested parameters. A positive control, which was high nitrogen (105.50 mg nitrogen applied per plant) added to the growth medium, and a water foliar spray. A negative control, which was low nitrogen (24.99 mg nitrogen applied per plant) added to the growth medium, and a water spray. The water spray used in these two controls is to eliminate the possibility that water sprayed on the leaves has an effect on the plants. A commercial check was used to simulate a foliar spray as currently available and was low nitrogen (24.99 mg applied nitrogen per plant) added to the growth medium, and a urea foliar spray. A second commercial check was used to simulate an alternative foliar spray as currently available and was low nitrogen (24.99 mg applied nitrogen per plant) added to the growth medium, and a urea and ammonium sulfate foliar spray. The tested formulation was a chitosan-based nanoparticle with 15.65 wt % nitrogen, 0.3 wt % chitosan for a nitrogen to chitosan ratio of 0.019. The chitosan-based nanoparticle was added to a foliar spray and was applied at 6.73+/−0.1 nitrogen per plant.

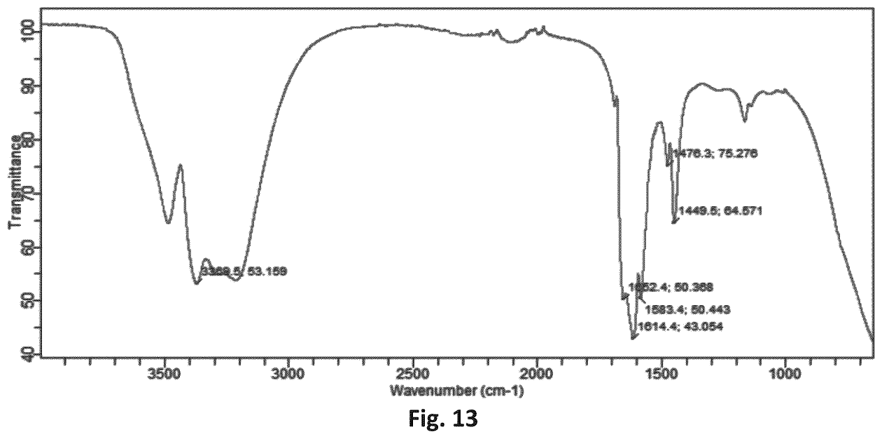

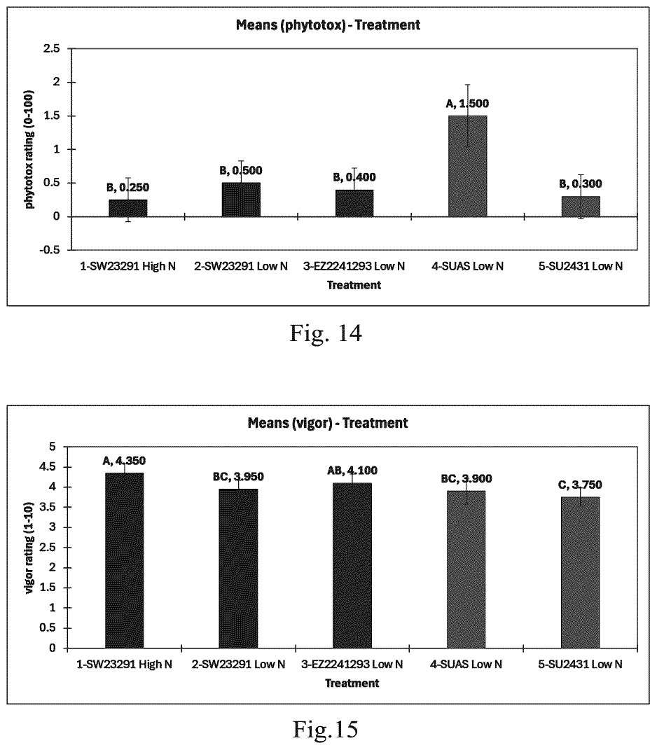

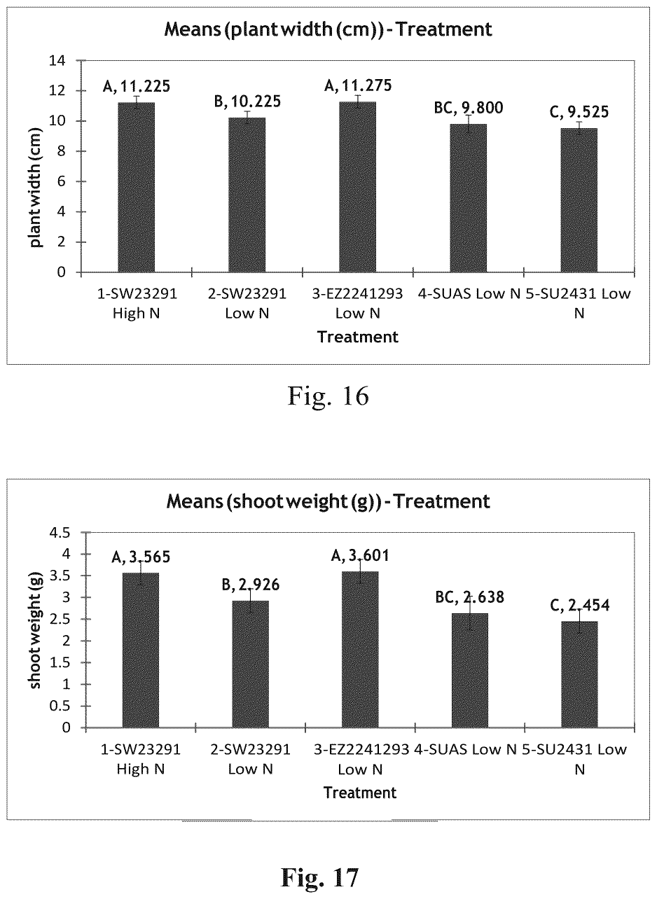

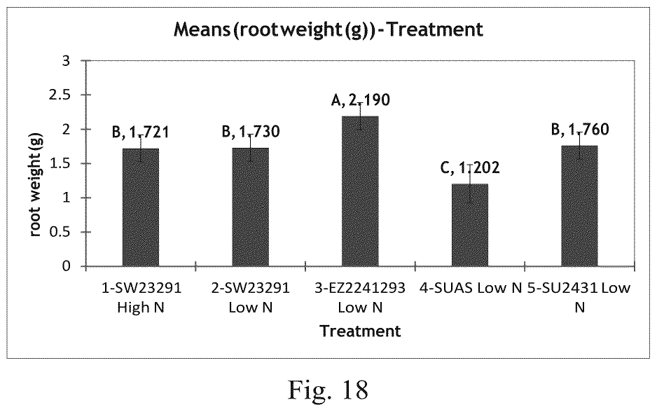

The Chitosan-based nanoparticle had a positive effect on the plants, resulting in larger plant width, increased shoot weight, increased vigor, increased root weight, and lower phytotoxicityFoliar sprays often have an adverse effect on plants as the substances in the sprays damage or burn the leaves. The chitosan-based nanoparticle has a statistically similar, minimal, phytotoxicity score to that of the positive control of high nitrogen in the hydroponic media and the negative control of low nitrogen in the hydroponic media. (FIG. 14) In contrast, a foliar spray of urea and ammonium sulfate has a statistically higher phytotoxicity rating. The phytotoxicity rating of chitosan-based nanoparticle being low demonstrates that a foliar spray with the chitosan-based nanoparticle results in less damage to a plant than a urea and ammonium sulfate based foliar spray. The effect of nitrogen on plants can be measured in several ways. For the hydroponic study using lettuce, plant vigor is one parameter which shows the effect of the nitrogen and the chitosan-based nanoparticle. (FIG. 15). The plants show greater vigor with the higher level of nitrogen in the hydroponic media, than the lower level of nitrogen in the hydroponic media. The addition of the chitosan-based nanoparticle makes up the difference between the high and low levels of nitrogen in the hydroponic media. In other words, the vigor of the lettuce plants which received the chitosan-based nanoparticle is statistically equivalent to the vigor of the lettuce plants which received the high level of nitrogen in the hydroponic media. Plant width is another parameter identifying the effect of the chitosan-based nanoparticle. (FIG. 16). The plants show greater width with the higher level of nitrogen in the hydroponic media, than the lower level of nitrogen in the hydroponic media. The addition of the chitosan-based nanoparticle makes up the difference between the high and low levels of nitrogen in the hydroponic media. In other words, the width of the lettuce plants which received the chitosan-based nanoparticle is statistically equivalent to the width of the lettuce plants which received the high level of nitrogen in the hydroponic media. The commercial checks were no better than the negative control. (FIG. 17). The plants show greater shoot weight with the higher level of nitrogen in the hydroponic media, than the lower level of nitrogen in the hydroponic media. The addition of the chitosan-based nanoparticle makes up the difference between the high and low levels of nitrogen in the hydroponic media. In other words, the shoot weight of the lettuce plants which received the chitosan-based nanoparticle is statistically equivalent to the shoot weight of the lettuce plants which received the high level of nitrogen in the hydroponic media. The commercial checks were no better than the negative control. Another parameter for measuring the effect of nitrogen is root weight. Roots expand and search for nitrogen and other nutrients. (FIG. 18). The high and low nitrogen in the hydroponic media are statistically equivalent. The chitosan-based nanoparticle results in an increase in the root weight of the lettuce plants, indicating that the lettuce plants which received the chitosan-based nanoparticle are benefiting the lettuce plants.

Several growth characteristics showed that replacing nitrogen with a lower volume of chitosan-based nanoparticle resulted in biomass yields that were at least equal to the biomass yield of the high nitrogen control. This means that the plants received as much benefit from a lower amount of nitrogen associated with a chitosan-based nanoparticle as the benefit from the high nitrogen. The high nitrogen provided 105.50 mg nitrogen per plant. The low nitrogen provided 24.99 mg nitrogen per plant. The chitosan-based nanoparticle added 6.73+/−0.1 mg nitrogen per plant. Therefore, the chitosan-based nanoparticle and the low hydroponic nitrogen together provided 31.72 mg of nitrogen to the plant, or a 70% reduction in the amount of total nitrogen applied to each plant. In other words, 80.51 mg of removed nitrogen was replaced by 6.73+/−0.1 mg nitrogen or 8.4% of the nitrogen removed from the high nitrogen was replaced by the nitrogen in the chitosan-based nanoparticle with an equivalent benefit.

The second experiment was a field study, where the chitosan-based nanoparticle was used in a foliar spray. This study was an off-season, small plot replicated study conducted in Florida.

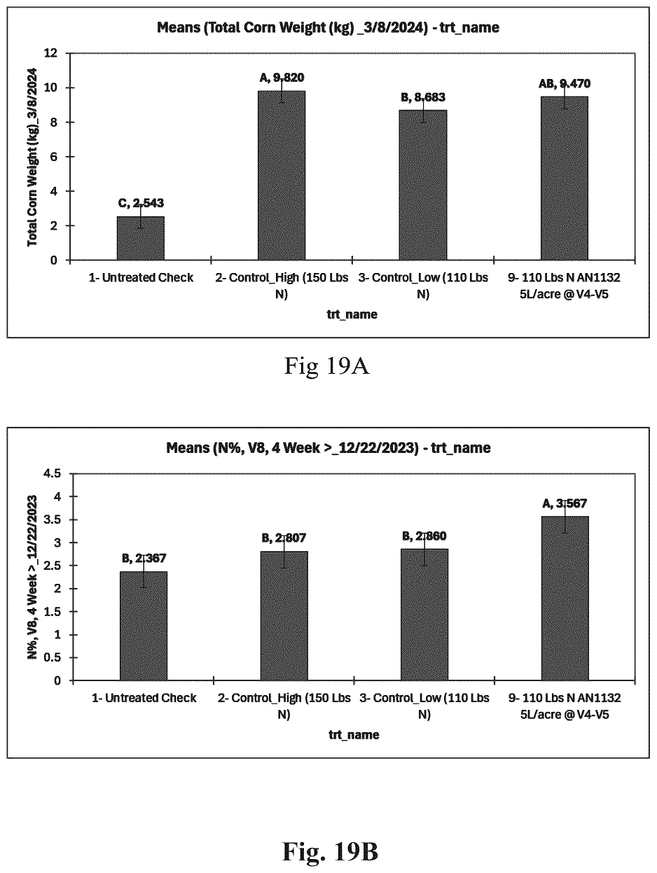

Corn plants were seeded in plots which were amended with either high nitrogen, at 68.04 kg/acre nitrogen) rate or low nitrogen at 49.90 kg/acre nitrogen). There was a high nitrogen (68.04 kg/acre nitrogen) control and a low nitrogen (49.90 kg/acre nitrogen) control. Three different chitosan-based nanoparticle formulations were sprayed on the different plots resulting in a high nitrogen and a low nitrogen plot for each chitosan-based nanoparticle. (FIG. 19A). The chitosan-based nanoparticle formulation was AN1132=0.2% chitosan, 12% N from Urea, 8% N from ammonium sulfate. LMW chitosan was used.

The formulations were sprayed on the plots at 5 l/acre. This results in a weight of nitrogen of about 1 kg/acre. Therefore, the 18.14 kg/acre of nitrogen that was removed from the high nitrogen to the low nitrogen was replaced in the low nitrogen with 1 kg/acre. The yield for at least some of the chitosan-based nanoparticle formulations was at least statistically equal to the yield of the high nitrogen. Therefore, the nitrogen was reduced by about 25% from the high nitrogen to the low nitrogen with the addition of the chitosan-based nanoparticle formulation with a statistically equal yield. Another way of stating this is that the total amount of nitrogen used in the low nitrogen plus the chitosan-based nanoparticle was about 75% of the nitrogen used in the high nitrogen with the same yield. Additionally, the nitrogen in the chitosan-based nanoparticle formulation replaced about 5.5% of the nitrogen removed from the low nitrogen. The low nitrogen plus the chitosan-based nanoparticle AN1132 resulted in higher levels of nitrogen in the leaves at the V8 stage than in the high nitrogen or low nitrogen control. (FIG. 19B).

A third experiment was the addition of a chitosan-based nanoparticle to corn fields fertilized with nitrogen according to accepted standard fertilization practices. Trials were conducted in Nebraska, Kansas, and Ohio. Plot sizes were roughly 10×45 feet, with 5 replicates per treatment. The test parameters included plots with an untreated control, that is no nitrogen fertilizer and no chitosan-based nanoparticle composition added; standard nitrogen plots, that is plots fertilized with nitrogen according to agricultural standards; standard nitrogen plus AN1113 chitosan-based nanoparticle solution sprayed at 5 l/acre at two points during growth; low nitrogen, nitrogen that is added at 18.14 kg/acre less than the standard nitrogen; and low nitrogen plus AN1113 chitosan-based nanoparticle solution sprayed at 5 l/acre at two points during growth. Across the trials, the total nitrogen applied in the chitosan-based nanoparticle+low nitrogen scenario was between 15-25% less nitrogen than the grower standard.

Nitrogen was applied according to the treatment definitions in Table 10. For standard base rate of nitrogen, nitrogen rates representative of local grower's standard practices for average yield potential were used, using the minimum of the acceptable range.

TABLE 10
Treatment Definitions

| | | Application A: | Applica- | Applica- |
|---|---|---|---|---|
| | | Nitrogen via | tion B: | tion B: |
| | | traditional soil | V5-V-6 | V5-V-6 |
| | Description | applied fertilizer | Foliar | Foliar |
| 1 | Check | None | — | — |
| 2 | Standard N | Standard N rate | — | — |
| 3 | Standard N + | Standard N rate | 5 L/acre | 5 L/acre |
| | Split Foliar | | AN1113 | AN1113 |
| | (10 L) | | | |
| 4 | Reduced N | Standard minus 18.14 kg N | — | — |
| 5 | Reduced N + | Standard minus 18.14 kg N | 5 L/acre | 5 L/acre |
| | Split Foliar | | AN1113 | AN1113 |
| | (10 L) | | | |

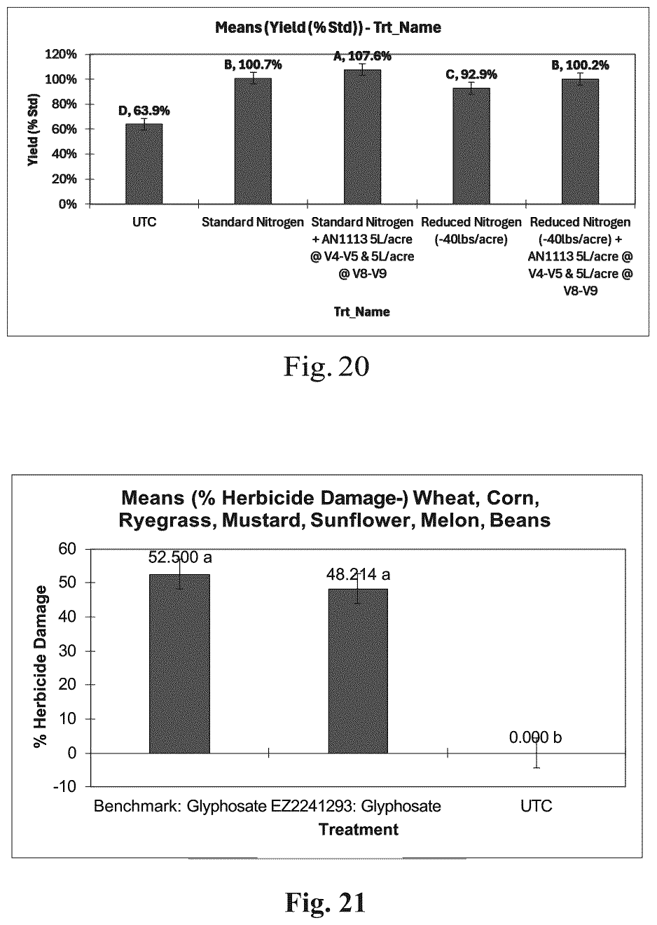

The addition of the chitosan-based nanoparticle to the standard nitrogen resulted in a 7% increase in yield (FIG. 20). The addition of the chitosan-based nanoparticle to the low nitrogen resulted in yields equivalent to the standard nitrogen yield.

The chitosan-based nanoparticle formulations may also be used in conjunction with other agri-inputs, for example used with herbicides. Experiments with multiple herbicides were performed to determine any synergistic effects and any antagonistic effects. Experiments were performed for two herbicides glyphosateand 2,4-D. Glyphosate showed no statistical evidence of antagonism when used with chitosan-based nanoparticle solutions. (FIG. 21). The glyphosate experiment involved the testing of seven different crops wheat, corn, ryegrass, mustard, sunflower, melon, and beans. Each crop was tested by having an untreated condition, a glyphosate condition, and a chitosan-based nanoparticle solution along with glyphosate. There was a statistical separation between the untreated condition and the glyphosate, and between the untreated condition and the chitosan-based nanoparticle solution along with glyphosate. There was no statistical separation between the glyphosate condition and the chitosan-based nanoparticle solution along with glyphosate condition.

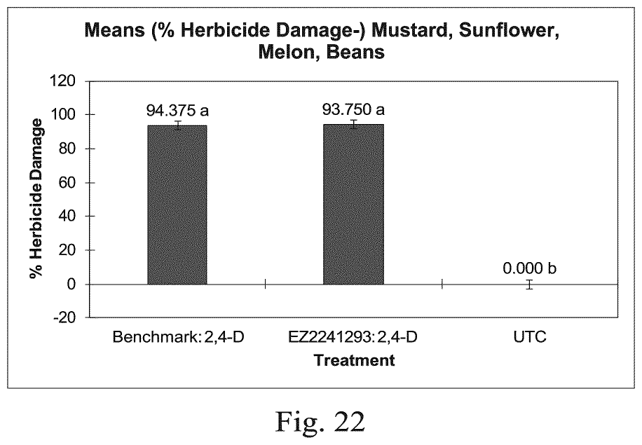

2,4-D showed no statistical evidence of antagonism when used with chitosan-based nanoparticle solutions. (FIG. 22). The 2,4-D experiment involved the testing of four different crops mustard, sunflower, melon, and beans. Each crop was tested by having an untreated condition, a 2,4-D condition, and a chitosan-based nanoparticle solution along with 2,4-D. There was a statistical separation between the untreated condition and the 2,4-D, and between the untreated condition and the chitosan-based nanoparticle solution along with 2,4-D. There was no statistical separation between the 2,4-D condition and the chitosan-based nanoparticle solution along with 2,4-D condition.

The invention has been described with reference to various specific and preferred embodiments and techniques. Nevertheless, it is understood that many variations and modifications may be made while remaining within the spirit and scope of the invention.

1. A composition comprising: chitosan between about 0.01% and about 4% (w/v) and at least 1% (w/w) nitrogen.

2. The composition of claim 1, wherein the nitrogen is between about 11% (w/w) and about 25% (w/w).

3. The composition of claim 1, wherein at least 50% of the nitrogen is in the chemical form of amine and/or nitrate and/or ammonia.

4. The composition of claim 3, wherein the composition comprises a nanoparticle of chitosan and a nitrogen rich compound and/or mixture of compounds selected from the group consisting of potassium nitrate, calcium nitrate, magnesium nitrate, urea nitrate, urea ammonia nitrate, ammonium nitrate, ammonium sulfate, ammonium hydroxide, urea-hydroxyapatite, amino acids such as arginine, cystine, histidine, leucine, lysine, methionine, threonine, tryptophan, tyrosine, valine, glutamine, glutamic acid, glycine, proline, taurine, aspartic acid, serine and alanine.

5. (canceled)

6. The composition of claim 1, further comprising a coupling enhancer.

7. The composition of claim 6, where the coupling enhancer is sodium tripolyphosphate and/or ammonium sulfate.

8. (canceled)

9. (canceled)

10. (canceled)

11. (canceled)

12. (canceled)

13. (canceled)

14. (canceled)

15. (canceled)

16. (canceled)

17. (canceled)

18. A method of treating a plant or a plant part, the method comprising treating the plant or plant part with a composition according to any of claims 1-7.

19. The method according to claim 18, wherein the plant part is selected from the group consisting of a seed, leaf, stem, flower, or root of a plant.

20. The method according to claim 19, wherein a predetermined amount of the composition according to any of claims 1-7 is used in place of a percentage of a traditional nitrogen fertilizer and produces an equal or better yield.

21. The method according to claim 20, wherein the predetermined amount of the composition according to any of claims 1-7 is between about 0.250 liters per acre and about 30 liters per acre applied in a foliar spray and is used in place of between about 0 kilograms per acre and about 150 kilograms of nitrogen units applied per acre of a traditional nitrogen fertilizer.

22. The method according to claim 21, wherein the predetermined amount of the composition according to any of claims 1-7 is about 5 liters per acre applied in a foliar spray using equipment that can generate droplet size between 0.0001 to 2 mm and is used in place of about 18.14 kilograms of nitrogen units per acre applied via traditional nitrogen fertilizer.

23. A method of preparing a plant growth medium, the method comprising treating the growth medium with a composition according to any of claims 1-7.

24. The method according to claim 23, wherein the growth medium is soil, peat, moss, wood residue, leaf mold, sawdust, bark, bagasse, rice hull, sand, perlite, vermiculite, calcinated clay, polystyrene, urea formaldehyde resins, agar, or agarose, in vitro and in vivo plant tissue culture/growth medium, and hydroponic liquids, medium for aeroponic and geoponic and combinations thereof.

25. The method according to claim 18, wherein the percentage of the composition used is between about 2 percent and about 7 percent of the traditional nitrogen fertilizer removed.

26. The method according to claim 25, wherein the percentage of the composition used is about 5.4 percent of the traditional nitrogen fertilizer removed.

27. The method according to claim 18, wherein the total nitrogen used is reduced by between about 70 percent and about 90 percent.

28. The method according to claim 27, wherein the total nitrogen used is reduced by about 70 percent.

29. A method of treating a plant part, the method comprising treating the plant or plant part with a composition according to any of claims 1-7 along with a standard amount of traditional fertilizer.

30. The method of claim 29, wherein treatment with the composition results in an improvement in yield of between about 0% and about 80%.

31. (canceled)

32. The Composition of claim 1, wherein the composition comprises a nanoparticle.
